(19) United States
(12) Patent Application Publication
(10) Pub. No.: US 2003/0066934 A1
(43) Pub. Date: Apr. 10, 2003

(54) Method of utilization a flow energy and power installation for it

(76) Inventor: Alexander Alexandrovich Bolonkin, Brooklyn, NY (US)

Correspondence Address: Alexander A. Bolonkin, 5 MOONEY ROAD, #E-10, FORT WALTON BEACH, FL, 32547, US

(21) Appl. No.: 09/946,497

(22) Filed: Sep. 6, 2001

(51) Int. Cl. F41J 9/08; A63H 27/08; B64C 31/06

(52) U.S. Cl. 244/153 R

(57) ABSTRACT

The author suggests a new method and a new inexpensive, large blade-rope type wind rotor, that will be suspended at high altitude and produce huge quantities of energy. The air installation embodiment includes (FIG. 25): propeller 220, wing 226, rope transmission 229, electric generator 12 located at ground.

Water rotors can utilize energy of ocean and sea streams.

The invention contains 11 projects: 6 for air, 1 for a river, 3 for the sea and ocean, and 1 for ships. They have a power capacity of up to 60 MgW (air), up to 200 MgW (water) for one unit.

The suggested installations have the following advantages:

1. Huge power production capacity—up to 5000-10000 times more than conventional ground-based rotor designs.

2. The rotor operates at high altitude of 1-14 kilometers, where wind has high speed and high stability (permanent flows).

3. The installation is much less expensive compared to conventional currently-employed windmills, partly because no tower is necessary to fix the rotor in space.

4. Wind energy is free —environmentally friendly.

### GROSS-REFERENCE TO RELATED APPLICATIONS

Not Applicable

### REFERENCE TO A MICROFICHE APPENDIX

Not Applicable

### BACKGROUND OF THE INVENTION

1. Field of the Invention

The present invention relates, in general, to methods and facilities for the utilization of flow (air, water) energy. The purpose is to dramatically increase the power capacity of a single installation and to decrease its cost per unit of power. The author suggests using a big flexible rope-blade free-flying rotor disposed at high altitude or in a water (sea) stream. The author also suggests using a rope device to transfer energy from the rotor to an electric generator.

2. Description of the Related Art

WIND POWER. Wind is a clean and inexhaustible source of energy that has been used for many centuries to grind grain, pump water, propel sailing ships, and perform other work. The amount of wind power available, however, varies depending upon the weather. Thus the windmills used to pump water have been largely replaced by electrically powered pumps.

Today wind power is used primarily in remote areas, but recent interest in fuel conservation has spurred development of modern wind machines for generating electricity. In the 1980s, producing a kilowatt-hour of wind energy cost about sixteen cents (installation included). Most wind machines have a horizontal shaft axis though some have a vertical axis. The best known horizontal axis machine in the United States is the American farm windmill frequently used to pump water. It consists of a rotor with up to 20 blades mounted on a horizontal shaft and a tail-vane to keep the rotor facing into the wind by swiveling the whole assembly. A set of gears and linkages connect to the pump rod, which moves vertically up and down. At a wind speed of 15 miles per hour (24 kilometers per hour), the pump delivers 10 gallons per minute (3.8 liters per minute) to a height of 100 feet (30 meters). Relatively inefficient, these pumps convert only a small portion of the wind stream energy to work as it passes through the rotor.

Unlike the traditional farm windmill, the modern efficient machines used to generate electricity have only one to four blades and operate at high rotor speeds. The blades look like the twisted airfoils of an airplane propeller. The Jacobs three-blade windmill, used widely between 1930 and 1960, could deliver about 1 kilowatt of power at a typical wind speed of 14 miles per hour (23 kilometers per hour).

More recently, large horizontal two-bladed wind turbines have been developed. The first of these, installed in Sandusky, Ohio, in 1975, had a 38-foot (12-meter) diameter rotor and was rated at 100 kilowatts (for wind speed more 7 m/s). Another model, with a rotor diameter of 400 feet (122 meters) and a shaft height of 250 feet (76 meters), produces 6,200 kilowatts of power at a wind speed of 29 miles per hour (47 kilometers per hour, 13 m/s). The first of these wind turbines was erected in Oahu, Hi.

First used in antiquity, vertical axis machines fell out of favor until the Savonius rotor arrived in the 1920s. It consists of S-shaped blades built from little more than an oil drum cut in half. An advanced version of this machine, coupled to a generator, produces 5 kilowatts of power in a 27 mile-per-hour (43 kilometer-per-hour, 12 m/s) wind.

Based on a 1931 patent by Darreus, the Sandia Laboratories in New Mexico in 1974 built a device with two aluminum rotor blades. The blades were tied to the shaft at the top and bottom and bowed out in the middle in such a way that they resembled the blades on a food mixer. The machine produced 60 kilowatts 10 of power in a 28 mile-per-hour (45 kilometer-per-hour) wind. Several models of this machine were built in 1980.

Wind farm is the term used for a large number of wind machines clustered at a site with persistent favorable winds, generally near mountain passes. Wind farms have been erected in New Hampshire, in the Tehachapi Mountains and at Altamont Pass in California, and at various sites in Hawaii. Machine capacities range from 10 to 500 kilowatts. In 1984 the total energy output of all wind farms in the United States exceeded 150 million kilowatt-hours.

A program of the United States Department of Energy encouraged the development of new machines, the construction of wind farms, and an evaluation of the economic effect of a large-scale use of wind power.

The utilization of renewable energy (‘green’ energy) is given a boost in current time. For example, a lot of wind turbines will be built around the British coast. The government is set to announce plans to develop a lot of off-shore wind farms around the coast of Great Britain in an attempt to increase the use of renewable energy sources. A total of $2.4 billion will be injected into renewable energy projects over (2001) the next three years in an attempt to meet the government's target of using renewable energy to generate 10% of the country's energy needs by 2010.

Giant wind turbines will be built on the sea bed in sites around England and Wales under a license scheme drawn up with the owners of Britain's coastline, Crown Estates. It saves the emission of almost a millions tons of carbon dioxide. Denmark plans to get about 30% of their energy needs from wind sources.

WATER POWER. The powerful hydraulic (water) turbine was developed in the mid-1800s. Turbines are enclosed waterwheels designed to take full advantage of the pressure and velocity of water. In 1849 James B. Francis, an American engineer, perfected the reaction turbine, also called the Francis turbine. Around the edge of this enclosed waterwheel, or runner, are blades called vanes. Water enters the enclosure and flows against the vanes. The vanes deflect the water, and the runner is spun by reaction. Hydroelectric plants often use Francis turbines with adjustable blades. The angle of such blades can be changed to increase a turbine's efficiency.

In 1890 L. A. Pelton designed the impulse turbine, also called the Pelton wheel. A high-pressure jet of water directed against “buckets” on the wheel's rim turns this turbine. About 1919, Forest Nagler developed another reaction turbine, called the propeller turbine. The propeller turbine is similar in principle to the Francis turbine, but the propeller has fewer blades than the Francis runner has vanes. Therefore there are larger spaces between blades, reducing the chance that the turbine will be damaged by debris in the water that passes through it.

Thus far, tidal power plants have not been economically feasible as a primary electricity source because of their intermittent power generation and their high construction costs.

Since 1900 the use of hydropower has steadily increased. The Columbia River drainage area, which is the site of the Grand Coulee, Bonneville, and Hungry Horse dams, has both the greatest potential and the greatest developed waterpower. California ranks second in the nation in potential waterpower, while the Ohio River basin is second in developed waterpower. Significant additional waterpower potential still exists in the Missouri and Ohio River basins and in the North and South Atlantic portions of the United States. The largest hydroelectric power plant in the United States is the Grand Coulee, which has a capacity of 7,600 megawatts.

Since 1930 most dams have been erected through federal or local agencies; however, private utility companies also have major plants on the Columbia River, on the Susquehanna in Maryland and Pennsylvania, on the Connecticut River in New England, and on the Saluda River in South Carolina.

Waterpower development by federal agencies is the responsibility of the United States Army Corps of Engineers, the Bureau of Reclamation, or the Tennessee Valley Authority (TVA). Except for TVA projects, federal waterpower developments are funded by selling electricity produced at federal dams that were originally built primarily for flood control.

In 1978, partly in order to encourage the production of electricity from renewable resources such as water and wind, the United States Congress passed the Public Utility Regulatory Policies Act (PURPA). The law required, in part, that utility companies buy electricity from small power producers, such as privately owned hydroelectric plants, at a price equal to what it would have cost them to generate the power themselves at a price termed the avoided cost rate. FERC estimated that, by 1995, the act would have stimulated the building of projects totaling 12,000 megawatts in capacity.

Unfortunately, current wind and water engines have deficiencies (defects) which impede their commercial applications:

1. Wind energy is distributed in space. It has small energy density. We cannot place big turbines on the ground. Many small turbines must be used instead. In California, there are thousands of small wind turbines. This is expensive. Big turbines do not produce enough energy (low wind energy density at ground level) and they are also very expensive.

2. At near ground level, wind has low speed and it is non-stable. Wind power is a function of the cube of wind speed. If wind velocity decreases by two times, the wind power decreases by a factor of 8 times. In short, wind has small power density near the ground. The capital costs are high for each installed unit.

3. The productivity of a wind-power system depends heavily on the prevailing weather.

4. Wind turbines produce noise and detract from the landscape.

There are many, many patents for the wind and water driven power generation systems.

The following is a list of benefits provided by the instant invention compared to these patents:

1. The suggested (rope-blade, flexible) rotor is very inexpensive, can be made with a very big size and captures wind energy from an enormous area (thousands of times more than typical wind turbines).

2. The suggested rotor is free-floating in the air or water. It can be located at high altitude (from 100 m to 14 km). The wind is much more strong at these altitudes. Its speed is 2-5 times greater than that near the surface. This means that the wind power obtainable at this altitude is 8-125 times greater than that available for installations near ground level (comparing systems with an equal “blade area”).

3. The wind is much more stable at high altitude. The wind may be zero near surface but it is typically strong and steady at high altitude. This can be seen when wind is absent on ground, but the clouds move in the sky. With the instant invention, the strong “permanent” wind streams in the stratosphere can be utilized.

4. With the suggested system, the energy transfer (for example, electric generator) is located at surface level.

5. With the suggested system, rope transmission lines are used to transfer energy from the rotor to the energy conversion device (electric generator).

6. With the suggested system, the rotor blades can be made of flexible fabric.

7. With the suggested system, the axes of the rotor can be located either horizontal or perpendicular to the flow.

8. With the suggested system, the wings (or rotor) provide additional support for the rotor.

9. With the suggested system, an expensive dam is not required.

10. With the suggested system, the turbine can be located in a sea stream.

As the result of these innovations, the suggested turbine system is one hundred times less expensive per unit of a power, can produce more than a thousand times more power per system, makes less noise at the surface (it is located at high altitude) and can be employed near towns or cities. At the present time, there are no known commercial turbines that take energy from a sea (ocean) stream.

### BRIEF SUMMARY OF THE INVENTION

The present invention relates, in general, to methods and facilities for utilization of a flow (air, water) energy. A method for the utilization of a flow energy comprising of the following steps: making a closed loop rope; connecting the rope to lift-drag devices and a flexible rope rotor; connecting the rotor to an energy (power) station (for example, electric generator) located on the ground, whereby a rope transfer system; situating the rotor to rotate as a free-fly (free-float) rotor with horizontal axis, and that is perpendicular or parallel to flow speed direction.

The Method Utilization can also comprise at least one of the following steps; situating the rope-flexible blade rotor in the air at a high altitude (100 m to 14 km); supporting the rope rotor with the lifting force of wings connected to the rotor; connecting the rope rotor to a surface with the rope; connecting the rope rotor to a surface with columns; connecting the rope rotor to a surface with rollers; disposing the rotor in the path of a water flow; controlling the blades with a stabilizer, elevator, flaps, and fin; employing parachutes as drag devices connected to the rotor rope at two points: end of parachute cord (shroud lines) and a canopy top of the parachute.

An Installation with a method of utilization of a flow energy comprising: closed-loop ropes; lift-drag devices connected to the closed-loop ropes; together with said ropes, forming a flexible rope rotor; energy station located on the surface and connected to the rotor; a rope transferor connecting the rotor to the energy station; rollers located at the rotor and at the surface and connected to said rotor and the surface; control devices which guide the lift-drag devices. The Installation may further include at least one of the following devices: wings that supports the flexible rope-blade rotor at an altitude; energy convertor such as electric generator, electric engine-generator; control devices such as stabilizer, elevator, flaps, fin; parachutes connected to the rope rotor, which are used as the drag devices; floating platforms connected to the rope rotor, providing support. The Installation can further include at least one of the following unusual features: blades, wings, and parachutes that can have at least one of the following designs: solid, inflatable, fabric, flexible plates; the parachutes are connected to the rotor rope at two points: end of parachute cord (shroud lines) and at the top canopy of said parachute. Installations located in the air flow at high altitude from 100 m up to 14 km. The Installation can be located in a water flow (stream of a river, sea or ocean). The suggested wind (water) installations are less expensive (per unit of a power) by hundreds of times, have more power by thousand of times, give more energy in thousands times, produce less noise (because located at high altitude) and can be disposed near towns or cities.

### BRIEF DESCRIPTION OF THE SEVERAL VIEWS OF THE DRAWINGS

FIG. 1a. A flexible rope-blade (high-altitude) air rotor (side view).

FIG. 1b. The flexible rope-blade (high-altitude) air rotor (front view).

FIG. 2a. A flexible rope-blade (high-altitude) air rotor with a support wing (side view).

FIG. 2b. The flexible rope-blade (high altitude) air rotor (front view).

FIG. 3a. An energy transferor (transmission)(front view)

FIG. 3b. An energy transferor (side view).

FIG. 4. Design of the oscillated clamp rollers (32, 38) of the transmission devices.

FIG. 5. Protection and guide cover of rollers (pulleys).

FIG. 6. connection of a blade axes (bulk) to the main rope.

FIG. 7. Main roller.

FIG. 8. Main rope with end of blade bulk in the groove of main roller;

FIG. 9a. Controlled blade in working position (side view).

FIG. 9b. Controlled blade (top side).

FIG. 9c. Controlled blade in non-working position (side view).

FIG. 10a. The rope rotor with fabric blades (side view).

FIG. 10b. The rope rotor with fabric blades (front view).

FIG. 11. The rope rotor with support wing or support rope,

FIG. 12. The rope rotor with the support rope (top view).

FIG. 13. The rope rotor with variable diameter rotor.

FIG. 14. A mechanism for changing the rope diameter.

FIG. 15. A fabric blade in a working position (side view).

FIG. 16. A fabric blade in a non-working position.

FIG. 17. A fabric blade (top view).

FIG. 18a. A rope rotor with blade-parachutes (rope-parachute rotor)(side view).

FIG. 18b. The rope rotor with blade-parachutes (rope-parachute rotor)(top view).

FIG. 19. Schema of rope-parachute rotor.

FIG. 20. Ground high speed power rope rotor.

FIG. 21a. High speed frame rope rotor (side view).

FIG. 21b. High speed frame rope rotor (front view).

FIG. 21c. High speed frame rope rotor (top view).

FIG. 22. Cross-section and aerodynamic forces of the controlled blade for all suggested blade rotors.

FIG. 23a. Flying high-speed rotor with parabolic blades and rope transferor (transmission) (side view). Marks are the same as FIG. 21.

FIG. 23b. Flying high-speed frame rope rotor (front view).

FIG. 23c. Flying high-speed frame rope rotor (top view).

FIG. 24a. High-speed propeller rope rotor (side view)

FIG. 24b. High-speed propeller rope rotor (front view).

FIG. 25a,b. High-speed propeller rope rotor which uses expansion as a transferor (transmission) (a—side view, b—front view).

FIG. 26a,b,c. Schema of the rope power transferor (reductor) for changing direction and revolution main rope roller (a—side view; b—front view; c—top view).

FIG. 26d. Ground power station.

FIG. 26e. Power transfer rope.

FIG. 27a,b,c. Wind Installation supported by air balloon. (a—front view, b—side view, c—top view).

FIG. 27d. Wind Installation with high-speed slope propeller [gyroplane (autogiro) propeller].

FIG. 28. High-speed propeller with an additional wing at ends (propeller jet).

FIG. 29. Double propeller with opposing rotation.

FIG. 30. High-speed propeller rope rotor with a support ropes (side view).

FIG. 31. High-speed propeller rope rotor with back cones and support ropes.

FIG. 32. Double high-speed propeller rope rotor with different opposing speeds of rotation and differing diameters (side view).

FIG. 33. Single-blade propeller.

FIG. 34a. Rope transmission of one-blade propeller (side view).

FIG. 34b. Rope transmission of one-blade propeller (front view).

FIG. 35a. Controlled blade (side view).

FIG. 35b. Controlled blade (side view, cross-section KK of blade on FIG. 35a).

FIG. 36a. End wing (propellerlet) (side view).

FIG. 36b. End wing (propellerlet) (front view).

FIG. 36c. End wing (propellerlet) (top view).

FIG. 37a,b. Reducer of revolutions (transmission) of the transferor.

FIG. 38a. Water rope rotor for river (side view)

FIG. 38b. Water rope rotor for river (top view).

FIG. 39a,b,c. Water high-speed rope rotor for river. a—side view; b—front view; c—top view.

FIG. 40a. Water low-speed rope rotor for sea and ocean stream (top view).

FIG. 40b. Water low-speed rope rotor for sea and ocean stream (front view).

FIG. 41a. A water drag parachute rope rotor (side view).

FIG. 41b. The water drag parachute rope rotor (top view).

FIG. 42a. A water high-speed rope rotor (front view).

FIG. 42b. A water high-speed rope rotor (side view).

FIG. 42c. A water high-speed rope rotor (top view).

FIG. 43a. Flexible blade that moves in the right and left directions.

FIG. 43b, Hinge blade. Figure shows the positions of the rotated leading and tailing blade edges in the right and left blade movements.

FIG. 43c. Blade controlled form when it gives a minimum drag.

FIG. 44. A sea ship moved by a wind engine.

FIG. 45. Water low-speed propeller rotor.

FIG. 46. Water high-speed propeller rotor.

FIG. 47a. Fabric flexible water low-speed propeller rotor (side view).

FIG. 47b. Fabric flexible water low-speed propeller rotor (front view).

FIG. 48. Propeller rotor in slope position when the wind speed is closed to zero.

FIG. 49. Propeller rotor in vertical position rotated by motor when a wind speed equals zero.

FIG. 50. Propeller rotor in non-working position (no rotation) when the wind is very strong and rotor blades have zero attack angle.

FIG. 51. Propeller rotor in non-working position (no rotation) when the wind is very strong and rotor blades is turned along rotor axis.

FIG. 52. Control for maximum power by the blade attack angle.

FIG. 53. Control for constant revolutions by the blade attack angle.

FIG. 54. Control for constant torque moment by the blade attack angle.

FIG. 55a. Roller (pulley) for a ribbon transfer rope (side view).

FIG. 55b. Roller (pulley) for a ribbon transfer rope (front view).

FIG. 56. Transfer ribbon with holes.

### DETAILED DESCRIPTION OF THE INNOVATION

### Method

The present invention relates, in general, to methods and facilities for the utilization of a flow (air, water) energy. The purpose is to dramatically increase the power capacity of a single installation and decrease the cost per unit of power. Author suggests use as a big flexible rope-blade free-flying rotor disposed at high altitude or in a stream of water (sea, ocean, river, etc.).

1. A Method of Utilization of a flow (stream) energy, comprising the following steps:

(a) connecting lift-drag devices to a rotor;

(b) connecting said rotor to the ground, with a connecting rope;

(c) disposing energy conversion station at the Earth surface;

(d) connecting said rotor to said energy conversion station with rope transferor;

(e) disposing said rotor to work as a free-fly (free-float) rotor;

(f) transferring rotational energy from said rotor to said energy station-with said rope transferor;

(g) controlling the altitude and power production of said rotor.

2. The Method of Utilization of a flow energy as recited in point 1, comprising at least one of the following steps:

(a) making a closed loop rope;

(b) using blades as lift-drag devices;

(c) connecting said lift-drag devices to said rope and getting a flexible rope rotor with parallel blades;

(d) connecting said lift-drag devices by one end to a rigid rotor axis (shaft) and attaching a propeller;

(e) disposing said rope-flexible blade rotor into the air at a high altitude of up to 14 km;

(f) supporting said rope rotor with the lift force of said blades;

(g) supporting said rope rotor with the lift force of a rotor wing connected to said rotor;

(h) supporting said rotor with an air balloon;

(i) supporting said rotor with a self-support slope propeller;

(j) supporting said connection rope with a connection rope wing;

(k) supporting said rope transferor with a transferor wing;

(l) connecting said rope rotor to a surface with columns;

(m) connecting said rope rotor to a surface with rollers;

(n) connecting said rope rotor to said energy station with at least one of the following devices: rollers, rope transferor, rope pulleys, spools, gear boxes, clutches or reverse mechanism;

(o) disposing said rotor into a water flow stream;

(p) controlling said blades and said rotor with at least one of the following devices: stabilizer, elevator, flaps, ailerons, fin or turn mechanisms;

(q) controlling said rotor support wings with at least one of the following devices: wing stabilizer, elevator, ailerons, flaps or fin and control devises;

(r) pressing said rotor and transfer ropes to said rollers with additional press rollers;

(s) changing revolutions of said rotor roller before transferring energy to said power station with a rotor gear box;

(t) using parachutes as said drag devices connected to said rotor rope at two points: end of parachute cord (shroud lines) and a canopy top of said parachute;

(u) connecting said blade at one point of the shaft and connecting to propeller rotor;

(v) disposing axis of said propeller in a direction of said stream;

(w) connecting said blade at several points to the central bulk with ropes and getting Darrieus form of rope rotor;

(x) disposing said Darrieus rotor and their bulk in a horizontal position in perpendicular direction to said flow;

(y) making said rope from artificial fibers, whispers, nanotubes, etc.;

(z) making said wing, blades, pulleys, rollers from composit material;

(aa) making said parachutes from artificial filaments;

(bb) lifting said rope rotor to said high altitude with said blades, wing, and variable rope connection and rope transferor;

(cc) initite rotation of said rotor with an engine located at surface and said transferor;

(dd) making said transfer rope in a ribbon form;

(ee) making said transfer rope in a ribbon form with holes and pulleys with teeth (cogged rollers).

3. The method of. Utilization of a flow energy as recited in point. 1, comprising at least one of the following steps:

(a) lifting said rotor with said rotor blades;

(b) lifting said rotor with said rotor support wing;

(c) lifting said propeller rotor with said power station;

(d) starting said rotor with a self starting mechanism;

(e) starting said propeller rotor with said power station;

(f) controlling (guiding) said propeller by turning said blades around their longitudinal axis;

(g) controlling said blades such they give a maximum torque moment;

(h) opening said parachutes when they are moving in direction of stream (flow) and packing (closing) them when they move against a direction of said stream;

(i) making said blades of said propeller from mobile sections which can be turned around on the longitudinal blade axis;

(j) controlling said propeller sections such that they give a maximum torque moment with at least one of the following devices: section stabilizer, elevator, flaps;

(k) making mobile blades from said Darrieus rotor;

(l) controlling angle of said mobile Darrieus blades such they give sufficient lift force for supporting said rotor at given altitude when they are in vertical position and maximum torque when they are in horizontal position while turning them around blade on a longitudinal axis;

(m) providing propellerlet at ends of said propeller rotor;

(n) controlling said propellerlet such they give sufficient average lift force to support propeller at given altitude when said blade is in vertical position, and minimum average drag when said blade is in horizontal position;

(o) controlling lift force of said support wings such that their average lift force is equal to the weight of air pats of said installation;

(p) controlling said blades such that forces are below the admissible load in rotor and rope;

(q) locating the center of gravity of a rigid system of said rotor

said rotor support wing in relative interval of 0.2-0.4 on average aerodynamic chord of said support rotor wing;

(r) connecting a top end of said connection rope to said center of gravity;

(s) spooling said transfer energy rope from one spool to other across said rotor and a reversing mechanism;

(t) changing direction of spooling using said reverse mechanism (when a spool is full)

(u) turning said propeller blades to a parallel position of said rotor axis when a wind speed is more than an admissible value;

(v) landing said rotor whereby decreasing of said rotor lift forces (for inspecting and repairing).

The main advantages of said method in air: the location in a free flow at high altitude and the rope transmission (transferor) of energy from altitude to surface. The main advantage of said method in water: the capability to use the sea (ocean) streams.

### Installation

The objective of this invention is: a) to increase the power capacity of a single unit of wind (water) installation, b) to decrease the cost per unit of power, c) utilize the energy of sea (ocean) streams, d) provide an energy source that is more stable.

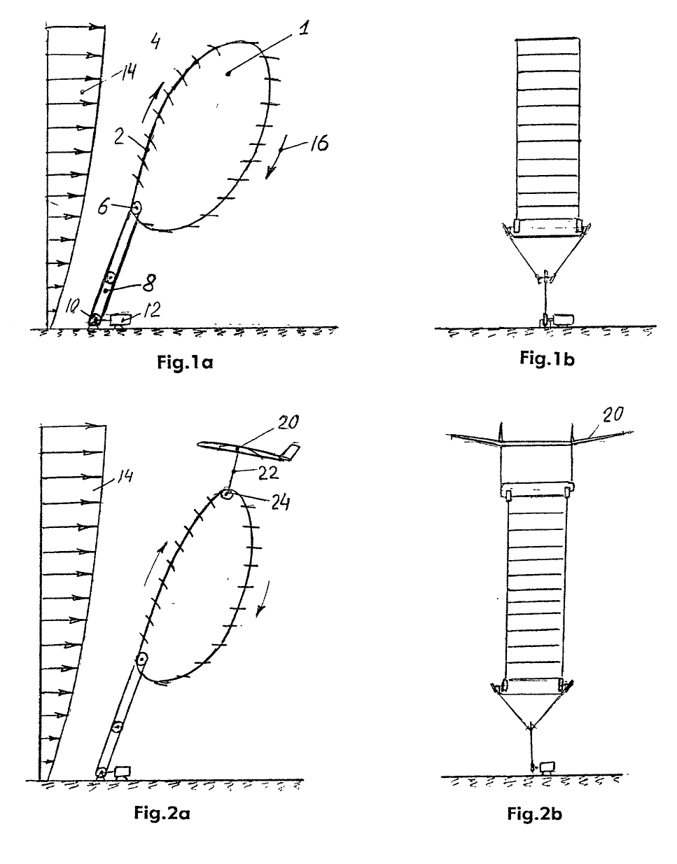

FIG. 1a shows a flexible rope-blade high altitude air rotor (side view). Notations: 1—rotor; 2—closed-loop rope; 4—blades; 6—main rotor rollers; a—energy transmission (energy transferor); 10—main ground roller; 12—energy station, energy converter (for example, electric generator, engine-generator); 14—wind; 16—direction of a rotor rotation.

FIG. 1b shows the flexible rope-blade air high-altitude rotor (front view).

The rotor works the following way: the wind 14 creates lifting force on the blades 2. This force moves the blades up and rotates the roller 6. The roller transfers this rotation by rope transmission 8 to roller 10. The roller 10 transfers the rotation to the electric generator 12 (energy station, converter).

When the blades 4 reaches the top of the rotor, the lift force (attack angle) decreases down to zero and moves to a lower point on the rotor.

FIG. 2a shows a flexible rope-blade high-altitude air rotor with a wing support (side view). Notations: 20—support wing. 22—wing rope; 24—wing roller.

FIG. 2b shows the flexible rope-blade high-altitude air rotor (front view).

This design of the rotor has an additional wing 20 connected by rope 22 to the roller 24, which supports the top end of the rotor. It works in the same manner.

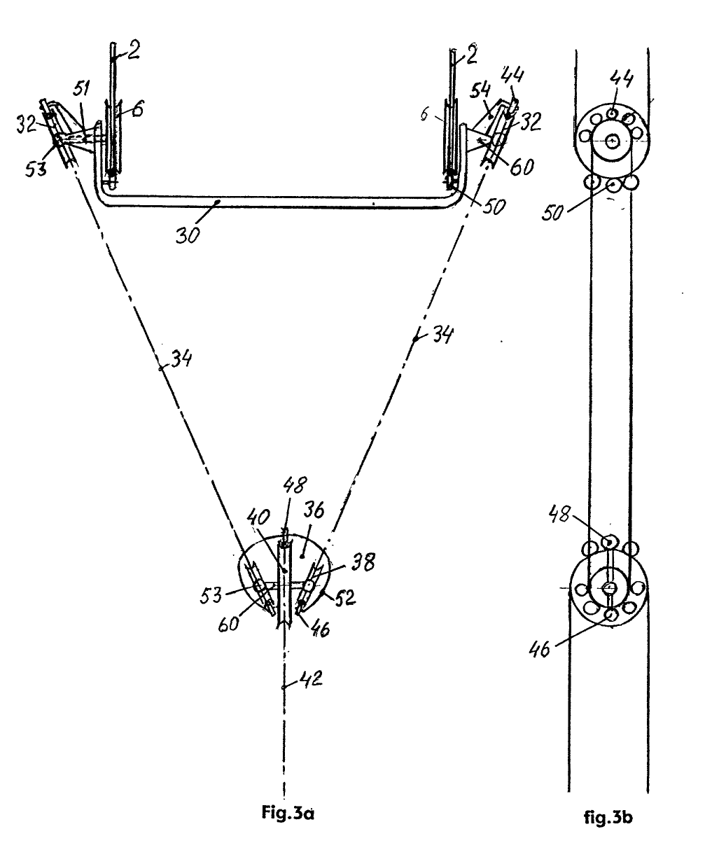

FIG. 3a shows an energy transmission (front view) device. Notations: 30—bracket (C-clamp); 32—clamp rollers; 34—transmission ropes; 36—triple rollers transmission devices; 38—clamp rollers; 40—central roller of triplet transmission device; 42—central rope of transmission device; 44,46,48,50—additional (press) rollers of the transmission device; 51—shaft of pulleys 6, 32; 52—bracket (C-clamp) of transmission device; 53—ball (-and-socket) joint, or swing unit (connection) of roller, or universal [Cardan] joint;

54—support of press rollers.

FIG. 3b shows the energy transmission (side view).

This part of energy transmission works in the following way. The ropes 2 transfer energy to roller 6, and the roller 6 to the roller 53, and the roller 53 transfers rotation by rope 34 to the roller 38 connected to the roller 40, and the roller 40 transfers the movement by rope 42 to the ground. Additional rollers 44,46,48,50 keep the ropes about rollers. The brackets 30,52 also retain the rollers.

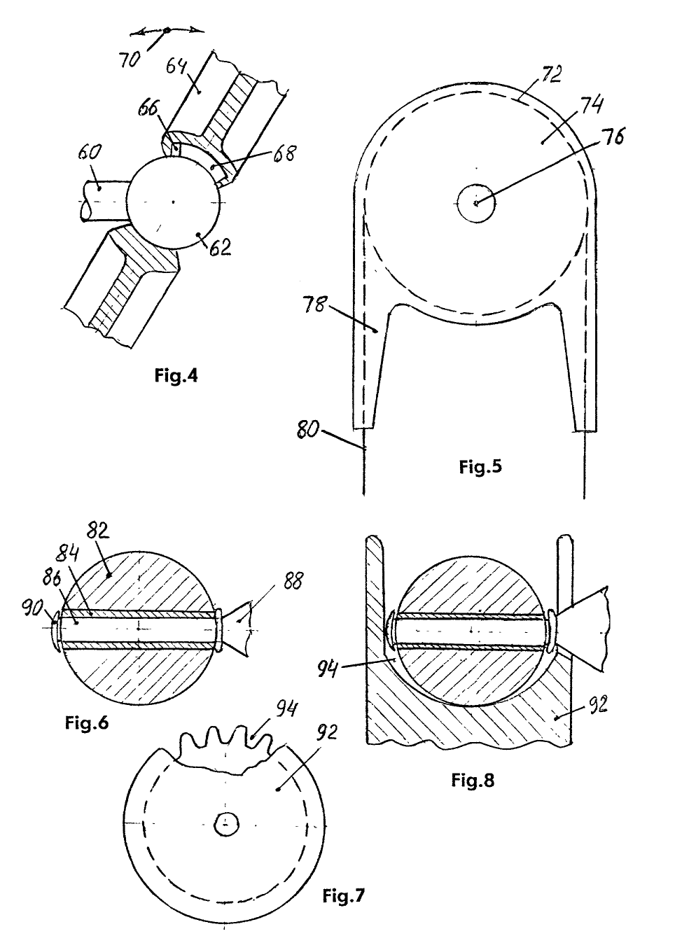

FIG. 4 shows a design of the oscillated clamp rollers (32, 38) of the transmission devices. Notations: 60—shaft; 62—spherical end of shaft ball joint; 64—oscillated roller (pulley); 66—bulge on spherical end of shaft; 68—groove in roller.

This mechanism allows the roller 64 to swing when it rotates around axis 60.

FIG. 5 shows a protection and a guide cover of the rollers (pulleys). Notations: 72—groove of roller; 74—roller (pulley); 76—axes; 78—guides; 80—rope. The Guide cover makes a permanent contact between the rope and the roller, and does not allow a disconnection between the rope and the roller (pulley).

FIG. 6 shows a connection of a blade axes to the main rope. Notations: 82—main rope; 84—bearing bush; 86—blade axes; 88—blade bulk; 90—lock (keeper, detent, retainer).

FIG. 7 shows the main roller (pulley). Notations: 92—main roller; 94—groove of main roller.

FIG. 8 shows the main rope with end of blade bulk into the groove of the main roller. The grooves make a permanent contact with the main rope and the main roller without sliding.

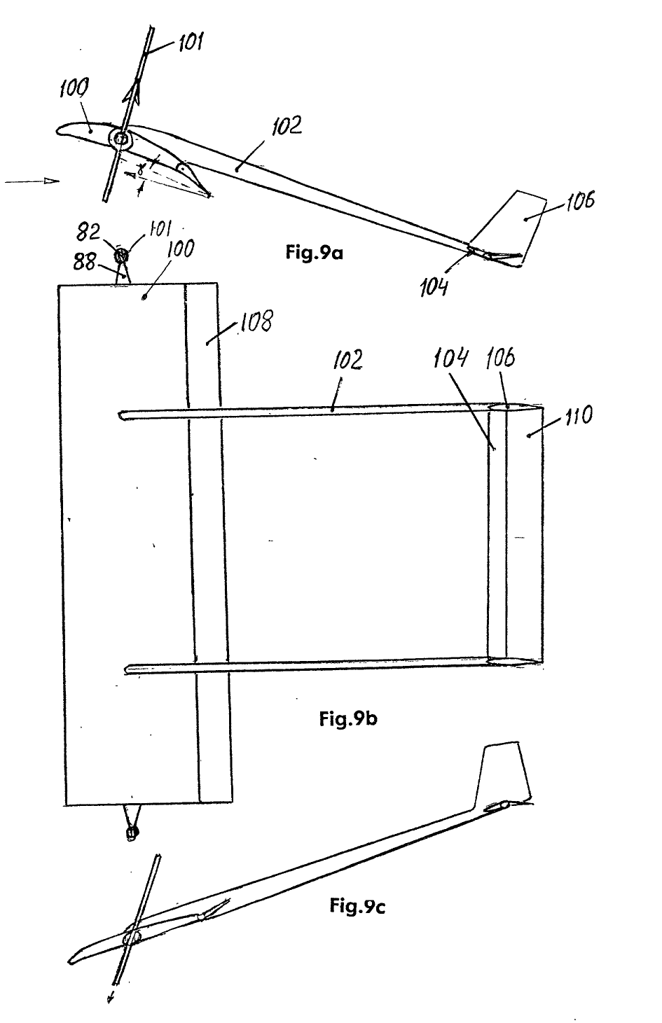

FIG. 9a shows a controlled blade in working position (side view). Notations: 100—blade; 101—main rope; 102—bulk; 104—stabilizer; 106—fin;

FIG. 9b shows the controlled blade (top side). Notations: 108—flaps; 110—elevator.

FIG. 9c shows the controlled blade in non working position (side view).

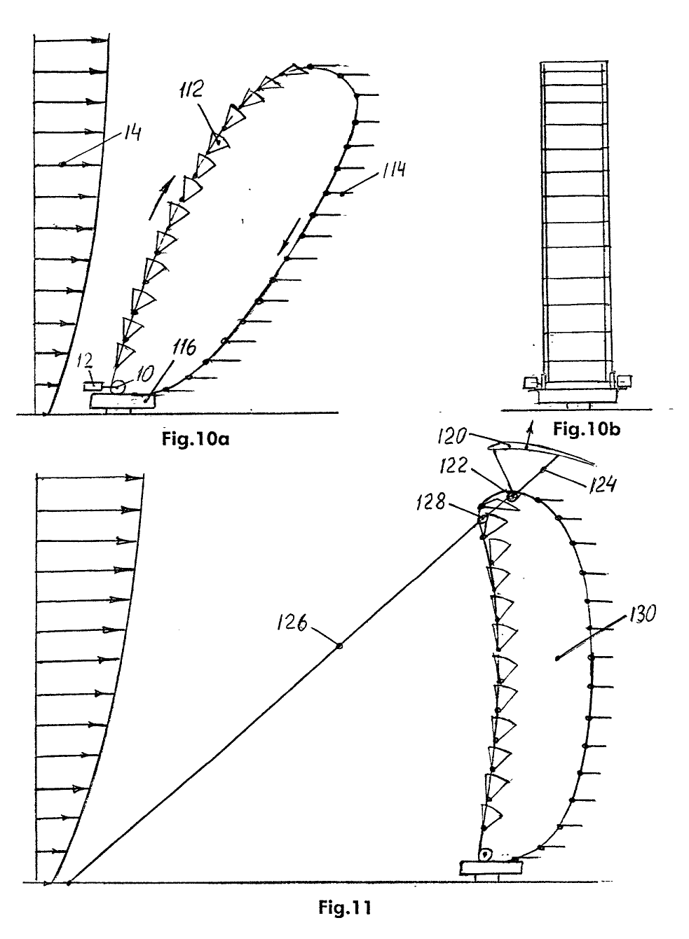

FIG. 10a shows the rope rotor with fabric flexible blades on a rotating ground platform (side view). Notations: 112—fabric blades in working position; 114—fabric blades in non-working position; 116—rotate platform.

FIG. 10b shows the rope rotor with fabric blades (front view).

The rotating ground platform allows to keep the rope rotor in line with the wind direction.

FIG. 11 shows the rope rotor with support wing and/or support rope. Notations: 120—support wing; 122—roller of support wing; 124—rope of support wing; 126—support rope of rotor; 128—roller of the support rope.

The support rope 126 increases the efficiency and stability of the rope rotor.

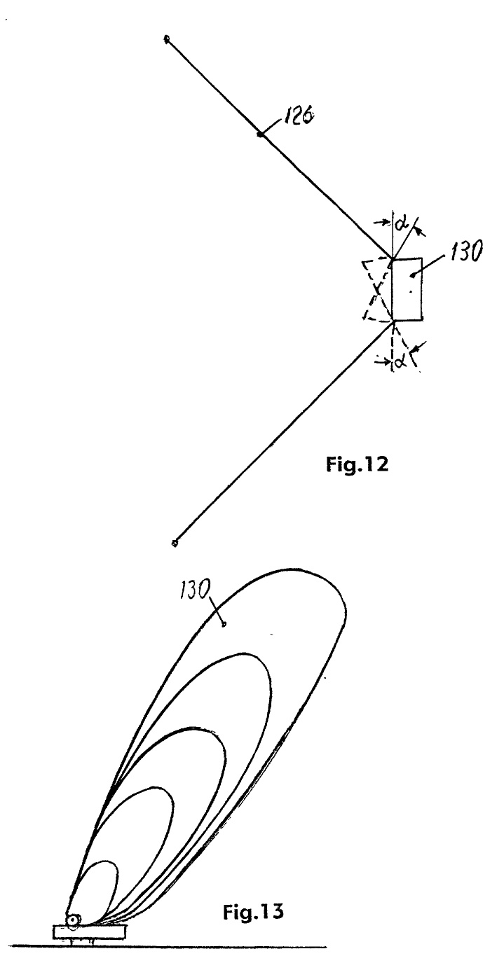

FIG. 12 shows the rope rotor with the support rope (top view). Notations: 130—rope rotor; α—angle rotation of rope rotor.

This design allows the use of the rope rotor for different directions of wind (limited by angle ±α).

FIG. 13 shows the rope rotor with variable diameter of rotor.

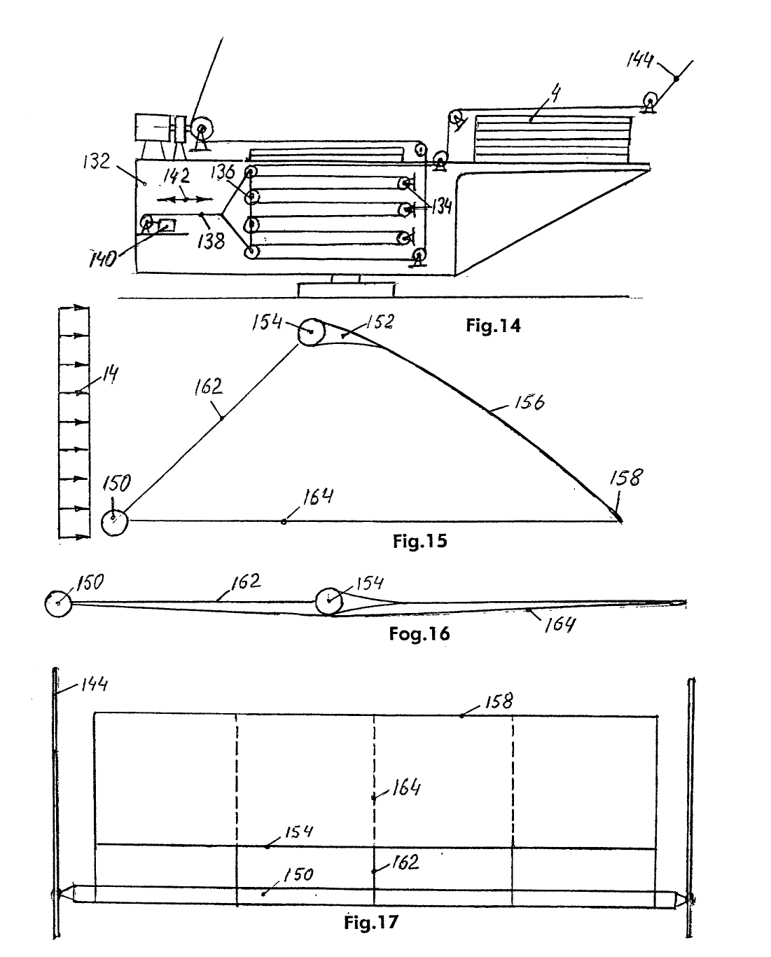

FIG. 14 shows a mechanism for changing the rope diameter (pulley mechanism, pulley block). Notations: 132—body; 134—immobile rollers (pulleys); 136—mobile rollers (pulleys)(pulley block); 138—rope of mobile rollers; 140—engine for changing of the rotor diameter; 142—directions of motion the mobile rollers; 144—main rotor rope.

The mechanism works the following way. The engine 140 decreases the rope 138. The pulleys 138 moves to right side and decrease the length of the rope 144. The additional blades 4 are connected to rope rotor 144. As a result the diameter of rope rotor 130 (FIG. 13) increases. When we want to decrease the diameter of the rotor, we move the rope 138 in the opposite direction (left), decreasing the length of the rope 144, disconnect a part of the blades 4, and storing them in place 4.

FIG. 15 shows a fabric flexible blade in a working position (side view). It may be used in air and water flows. Notations: 150—blade bulk; 152—fabric blade; 154—leader edge (rigid or inflatable); 156—fabric (or flexible thin light plate); 158—trailing edge; 162—rope of the leader edge; 164—rope of the trailing edge.

FIG. 16 shows the fabric blade in a non-working position.

FIG. 17. The fabric blade (top view). Notations are same with FIG. 15.

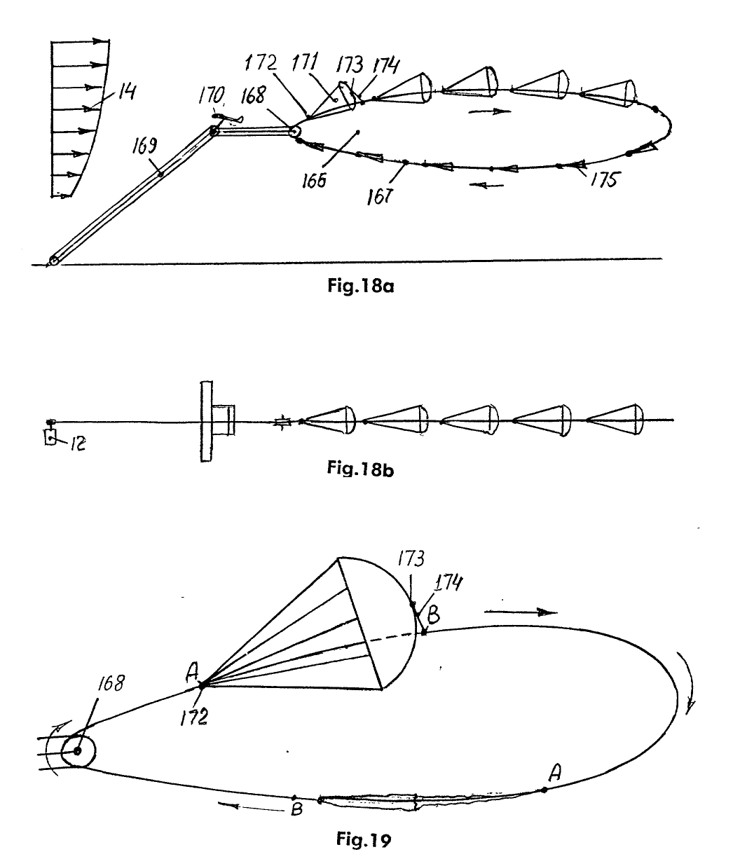

FIG. 18a shows a rope rotor with blade-parachutes (rope-parachute rotor)(side view). Notations: 166—rotor; 167—rope; 168—main roller (pulley); 169—energy transferor; 170—support wing; 171—blade-parachute; 172—the first point of a connection the parachute cord (shroud lines) to the main rotor rope; 173—the second point of a connection the parachute top to the main rotor rope; 174—parachute rope which connects the parachute canopy top to the main rope; 175—blade-parachute in packet position.

FIG. 18b shows the rope rotor with blade-parachutes (rope-parachute rotor)(top view).

FIG. 19 shows schema of the rope-parachute rotor. A,B—the points of the parachute connections.

The rope-parachute rotor 166 works in the following way. The open parachutes 171 pull the rope 167 and rotate the roller (pulley) 168 (FIG. 18a). The rope transmission (transferor) 169 transfers the energy to the electric generator (or engine) 12.

When the parachutes reach the right end of the rotor and begin to move against the wind, the rope 174 (point B) located ahead of a canopy of parachute and the parachute canopy collapses into a packet position and has a minimum of aerodynamic drag.

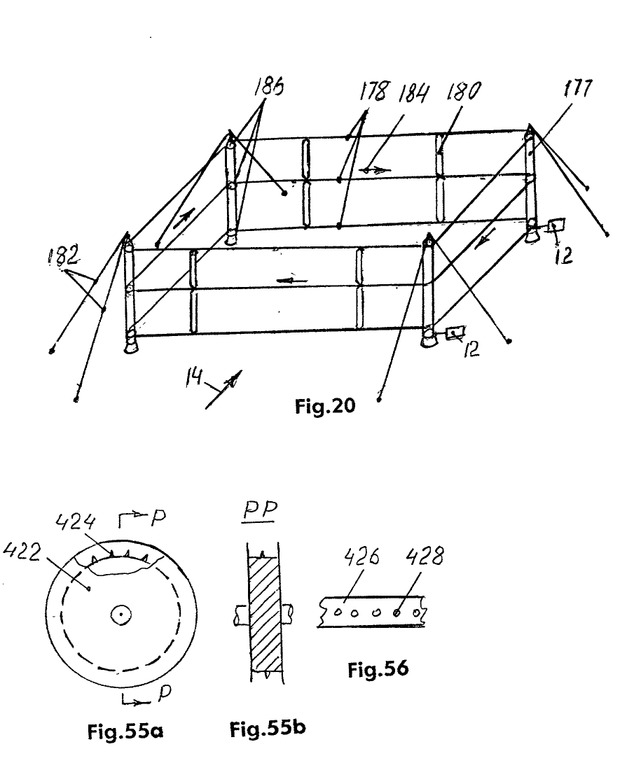

FIG. 20 shows the ground high-speed power rope rotor. Notations: 177—columns; 178—main ropes; 180—blade; 182—tension elements (expansions, spreading, stretching) for a supporting columns; 184—direction of rotation; 186—rollers (pulleys). This wind installation works the following way. The wind presses to the blades 180 and moves them around rollers 186 in direction 184. The angle of blades is controlled via the direction of wind. The energy of rotation of the rollers is transferred to the electric generator 12.

A unique performance feature of this design is its large work area and a big power capacity. Some of the unique design features are the rope rotor with vertical axis, the columns with rollers and the blade control.

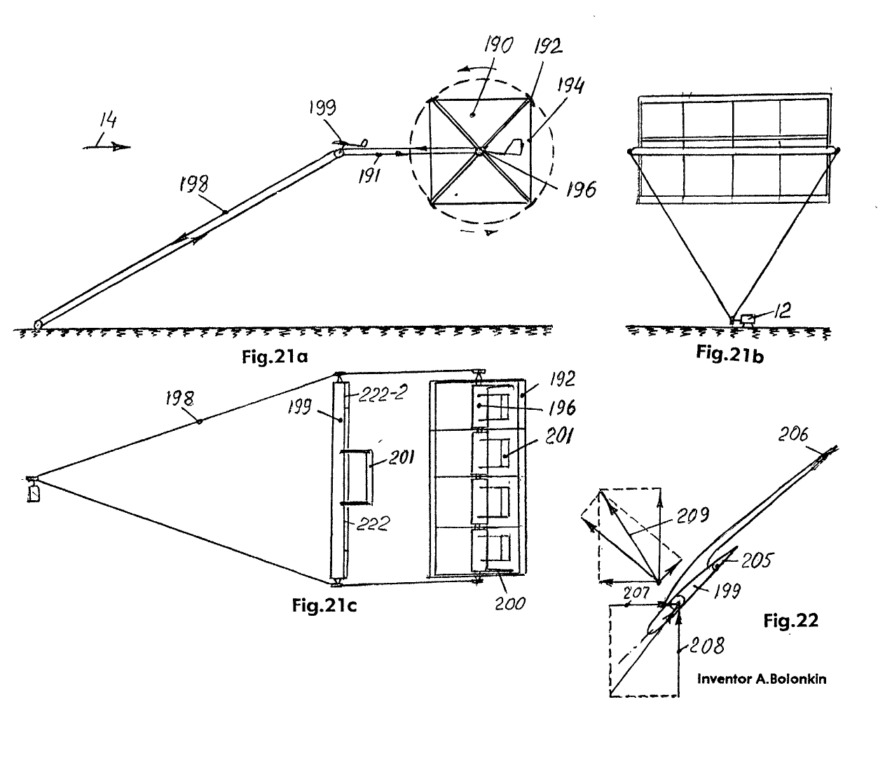

FIG. 21a shows a high-speed frame rope rotor with rigid blades (side view). Notations: 190—rotor; 191—transfer rope; 192—controlled blades; 194—ropes; 196—central wing or bulk; 198—rope transferor (transmission); 199—wing for support rope transmission.

FIG. 21b shows the high-speed frame rope rotor (front view).

FIG. 21c shows the high-speed frame rope rotor (top view). Notations: 200—fin of the central wing; 201—stabilizer of wing.

FIG. 22 shows a cross-section and the aerodynamic forces of the controlled blade for all suggested blade rotor positions. Notations: 205—flap; 206—elevator of a stabilizer; 207—blade speed; 208—wind speed; 209—wind force.

This wind installation works in the following way. The wind 14 rotates the rope rotor 190. This rotation is transferred by rope 191,198 to the ground electric generator 12. The general blade force 209 has vertical and forward parts (FIG. 22) which support and rotate the rotor. The control is made by the elevator 201, and flaps 205.

This wind installation uses a Darrieus rotor having rope design, horizontal axis, straight blades, free location at a high altitude and rope transmission and blade control.

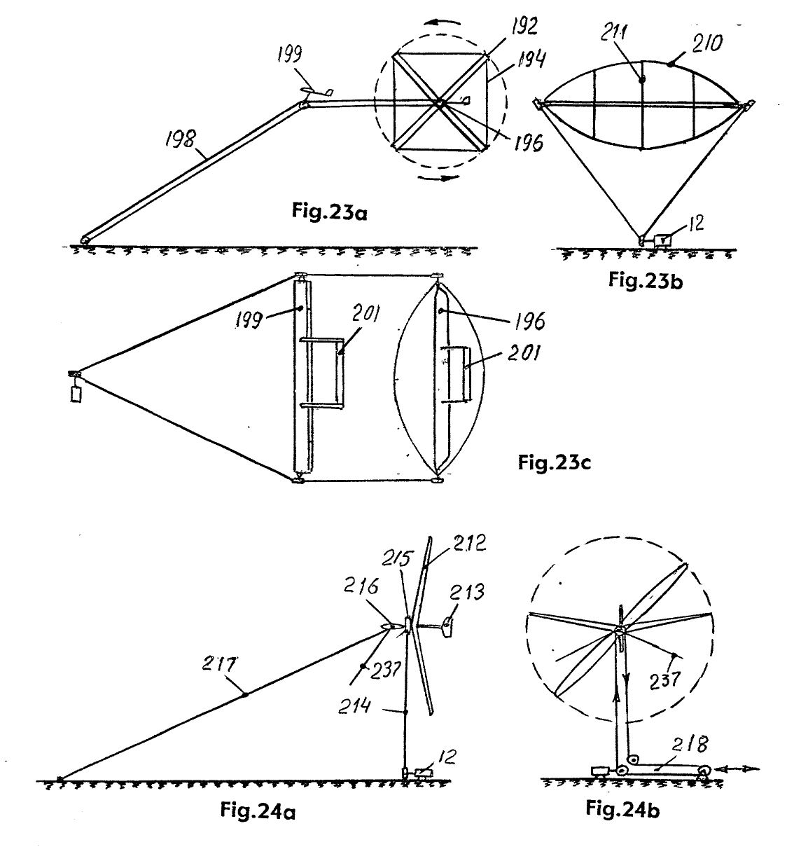

FIG. 23a shows a flying high-speed rotor with parabolic blades (Darrieus form rotor) and rope transmission (side view). The marks are the same as with FIG. 21: 210—parabolic blade; 211—tensile element of blade;

FIG. 23b shows the flying high-speed frame rope rotor (front view).

FIG. 23c shows the flying high-speed frame rope rotor (top view).

The installation works in the same fashion as with installation in FIG. 21.

FIG. 24a shows a high-speed propeller rope rotor (side view). Notations: 212—propeller; 213—stabilizer, elevator, and fin; 214—power rope transferor; 215—gear box (transmission, reduction); 216—wing with ailerons and flaps; 217,237—tension elements (expansion).

FIG. 24b shows the high-speed propeller rope rotor (front view). Notation: 218—control mechanism of altitude; γ angle of V-wing.

The propeller 212 transfers its rotation to the electric generator 12 by transmission (transferor, rope) 214. The installation has the control mechanism 218, which allows a change in altitude of the propeller location. Tensile element 217 allows a change in position of the installation when the direction of the wind changes. It is the same as with FIG. 12.

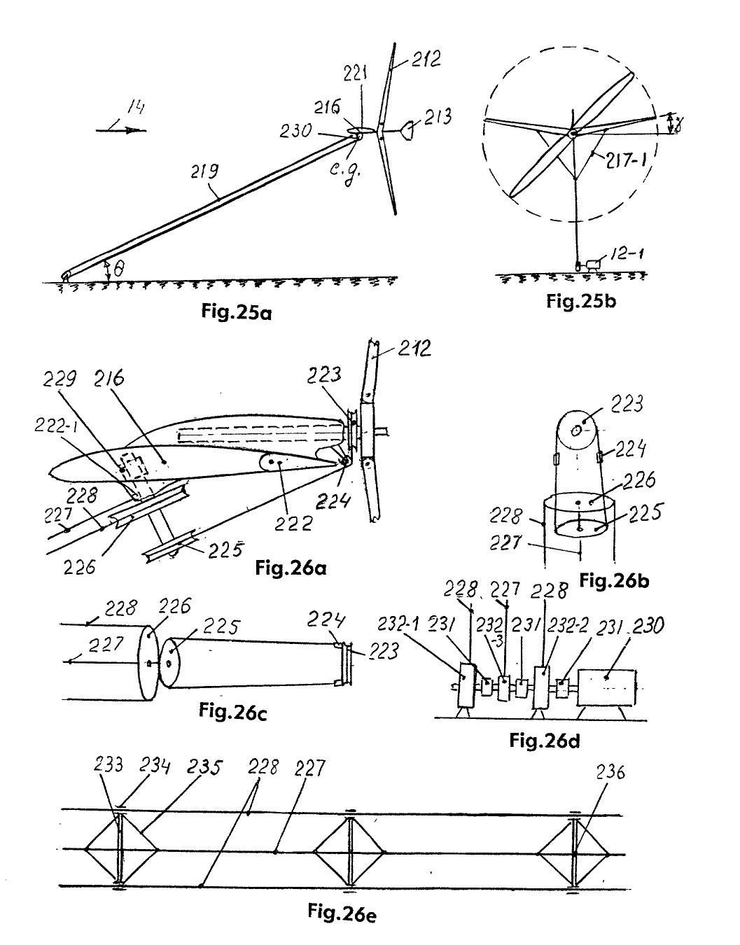

FIGS. 25a,b show a high-speed propeller rope rotor which use the expansion as a transmission (a—side view, b—front view). Notations: c.g.—center of gravity and point of connection of the main rope; 217-1 tension elements; 219—transmission (rope transferor of a power); 220—rope transmission (reductor); 12-1 energy station (motor-generator plus energy storage); θ—angle of main rope to horizon.

The propeller 212 transfers its rotation across reduction (rope, gear) box 220 and rope transmission 219 to the electric generator 12. The energy storage mechanism contains an inertial flywheel connected to a motor-generator.

FIGS. 26a,b,c show a schematic rope power transferor [reduction (transferor) box, transmission] for changing the direction and revolution speed of the main rope roller (a—side view; b—front view; c—top view). Notations: 222—ailerons, flaps; 222-1—sensor of stress; 223—roller (pulley) of blades; 224—auxiliary rollers; 225,226—rollers (pulleys) of transfer rope; 227—main rope; 228—power transfer rope; 229—reverse mechanism for changing direction and revolution power transfer rope.

FIG. 26d shows the ground power station 12-1. Notation: 230—energy station, energy converter (for example, electric motor-generator); 231—gear boxes, clutches, reverse mechanisms; 232-1,232-2,232-3—spools of rope.

FIG. 26e shows the power transfer ropes. Notations: 233—distance bar; 234—plain (slide) bearing; 235—expansion; 236—sensor of the wind speed and wind direction.

The central rope 227 is immobile rope that keeps the installation in a given position in the air. The rope 228 transfers energy from the installation to the ground. The installation works in the following way. Rotation of the propeller transfers through a set of pulleys (rollers) 223,224,225,226, reverse 229, ball joint (FIG. 4), the rope 219 to the energy transferor 12-1. It may be the electric generator-motor 230 FIG. 26d. The rope 228 is reeled by the propeller 212 from the spool 232-2. The propeller rotates the motor-generator 230 through the gear boxes, clutches, reverse mechanisms 231. Simultaneity, the generator 230 winds the other end of the rope 228 to the spool 232-1. When the spool 232-1 will be filled, the reverse mechanisms 229, 231 switches on a back rotation and continues to rotate the generator (and rotor) in one direction. When the spool 232-2 becomes filled, the reverse mechanisms switches the spools 232-1, 232-2 on the reverse rotation.

The sensors 236 of wind speed and direction allows the optimal altitude to be found where the wind power (speed) is the most strong. The spool 232-3 allows the altitude of the installation to change, to keep the altitude where a wind has the most speed. The control mechanism 221 allows to keep the installation in a given position by ailerons (to create a counter torque) and tail 213 and to control a stress of the rope 228 by flaps 222.

Location of the center of gravity (c.g.) and a point of connection the main rope 227 is very important for the stability of the installation. They must be located in the relative interval 0.2-0.4 of the aerodynamic chord of the main support wing 216. The difference in an aileron angle balances the torque moment of the rotor (propeller). In addition, the installation has the tension elements 217-1 which together with the wing angle γ provide automatic stability of the rotor around the longitudinal axis of the rotor. The installation can also have a gyroscopic sensor connected with ailerons. This sensor keeps the wing in horizon position.

The stress sensor 222-1 connected to the flaps 222 and rope 227 help maintain the given altitude by flap control (control of angle of the flaps). The weight of the rotor plus cables must be equal to the lift force. The stabilizer (fin) 213 keeps the rotor against the wind direction 14 and can automatically help to maintain wing longitudinal stability.

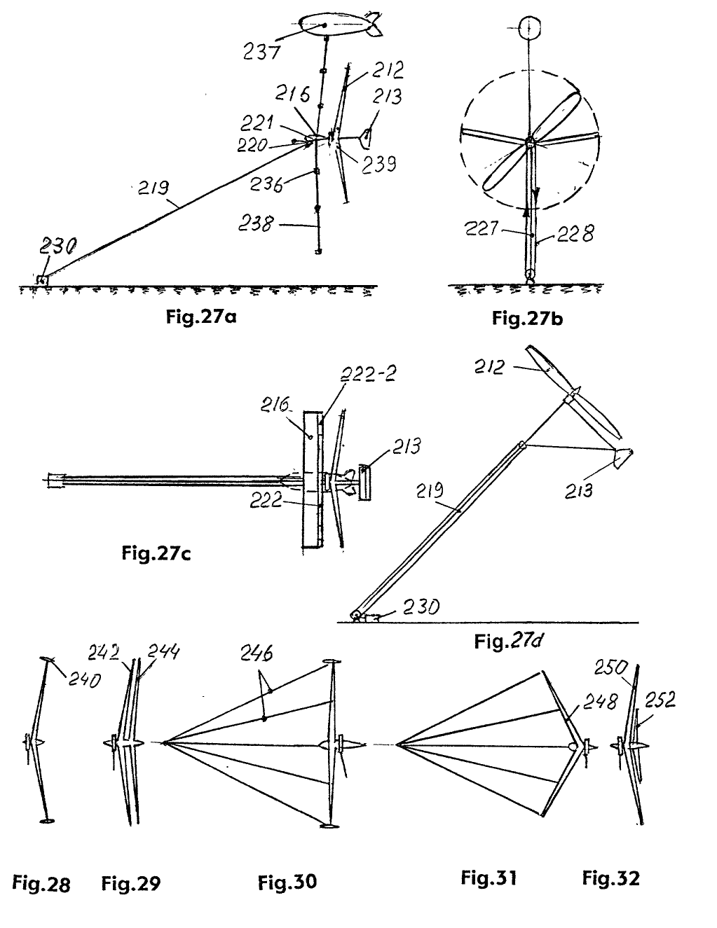

FIGS. 27a,b,c show the wind installation supported by air balloon (side, front, and top views respectively). Notations: 222-2 ailerons; 237—balloon (dirigible); 238—rope for the wind sensors (sensor rope); 239—hinge. All other notations are the same as with previous figures.

The balloon 237 supports the wind installation in the air on a windless day. The wind sensors 236 on the rope 238 allow the maintenance of the optimal altitude. The hinge 239 allows a decrease in the propeller diameter when the wind speed is over the admissible limit.

FIG. 27d shows the wind installation a with high-speed slope propeller [gyroplane (autogiro) propeller]. This installation does not utilize a support wing. The slope propeller creates sufficient lift force to support the installation at this altitude. This installation is more simple, but it may be more difficult to start.

FIG. 28 shows a high-speed propeller with an additional wing at the ends (propellerlet). Notations: 240—additional wing at the ends of propeller (propellerlet).

FIG. 29 shows a double propeller with opposing rotation. Notations: 242—forward propeller; 244—back propeller.

FIG. 30 shows a high-speed propeller rope rotor with support rope (side view). Notations: 246—tensile elements (support ropes).

FIG. 31 shows a high-speed propeller rope rotor with back cones and support ropes. Notation: 248—blade.

FIG. 32 shows a double high-speed propeller rope rotor with a different opposite speed of rotation and a different diameter (side view). Notations: 250—main propeller; 252—additional propeller with different opposed speed of rotation.

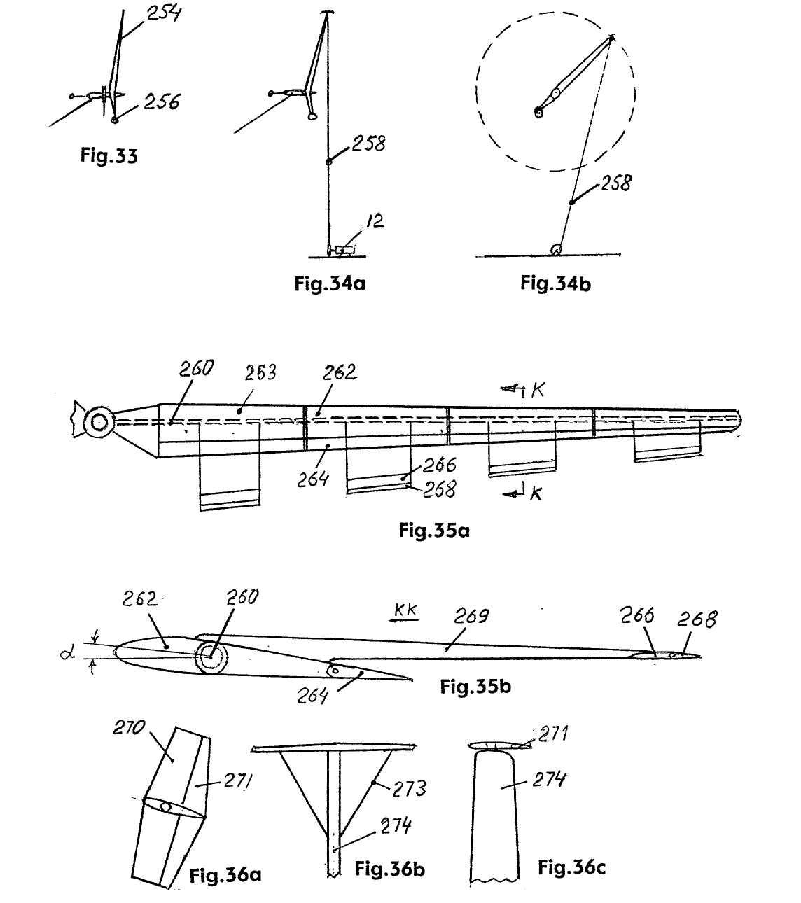

FIG. 33 shows a one-blade propeller. Notations: 254—blade; 256—counterweight (balance mass).

FIG. 34a shows a rope transmission of one-blade propeller (side view). Notation: 258—rope transmission.

FIG. 34b shows a rope transmission of one-blade propeller (front view).

The periodical change of rope length 258 transfers to the electric generator 12.

FIG. 35a shows a high-efficiency controlled blade (side view). Notations: 260—central tube (longitudinal axis); 262—wing; 263—sections of the wing which can rotate around tube (axis) 260; 264—flap; 266—stabilizer; 268—elevator.

FIG. 35b shows the controlled blade (side view, cross-section KK). Notation: 269—stabilizer bulk; α—attack angle of an average aerodynamic propeller chord.

The blade works the following way. Blade is separated on sections 263 which can rotate around tube (axis) 260 and are controlled by stabilizer 266, flaps 264, and the elevator 268. This allows to attain high-efficiency while protecting the installation from a storm.

FIG. 36a shows an end wing (propellerlet) (side view). Notations: 270—wing; 271—flaps.

FIG. 36b shows the end wing (propellerlet) (front view). Notations: 273—tension element; 274—blade;

FIG. 36c shows the end wing (propellerlet) (top view).

The using of the propellerlet allows an increase in the efficiency of the propeller.

FIG. 37a,b shows a reduction box of propeller for transmission (a—front view, b—side view). Notations: 275—blade; 276—wing; 277—gear box; 278—power transfer rope; 279—pulley.

The propeller 275 rotates the gear box 277, pulley 279, and the transmission rope 278.

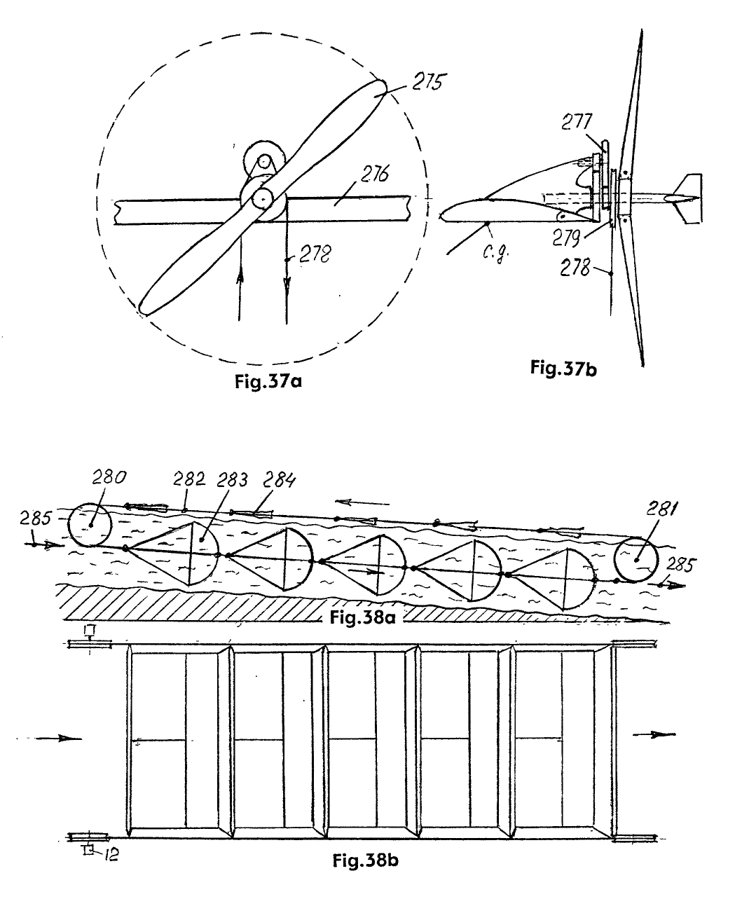

FIG. 38a shows a water rope rotor for river (side view) application. Notations: 280—leader roller (pulley); 281—tailing roller (pulley); 282—main rope; 283—fabric (type) flexible blade in working position; 284—fabric blade in non-working position; 285—water speed.

FIG. 38b shows the water rope rotor for river (top view).

The water rope rotor works the following way. The water flow 285 creates the drag (thrust) on the fabric blades 283. This thrust (force) rotates the pulley 280 which is connected across a gear box to the electric generator. When the blade moves in a backward direction, the connection B packs them into a small volume having low drag.

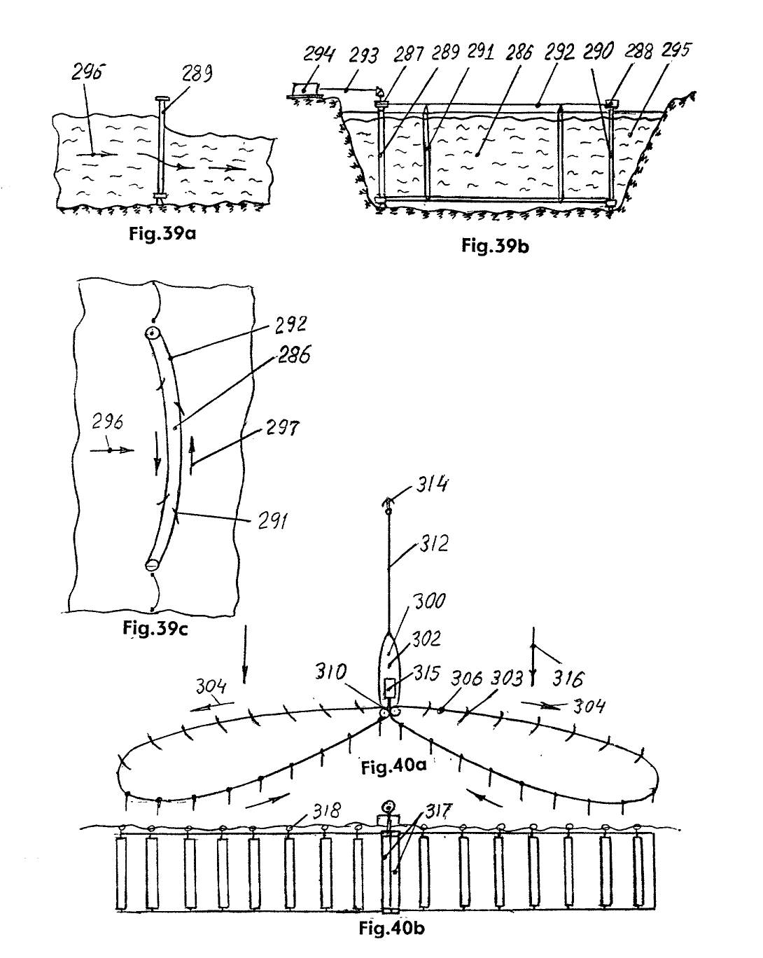

FIGS. 39a,b,c show a water high-speed rope rotor for river application: a—side view; b—front view; c—top view. Notations: 286—water installation; 287,288—main rollers (pulleys); 289,290—column; 291—blade; 292—main rope; 293—transmission; 294—energy station (for example, electric generator); 295—side fabric (type) flexible cover; 296—flow; 297—direction of a blade motion.

This installation works in the following way. The water flow 296 presses to blades 291 and moves them with high force in direction perpendicular to the flow direction. The blades rotate the pulleys 287. The pulley 287 rotates across the transmission 293 and the electric generator 294.

FIG. 40a shows a water low-speed rope rotor for sea and ocean stream (top view). Notations: 300—installation; 302—floating platform; 303—blades; 304—movement of blades; 306—main rope; 310—main rollers (pulley); 312—tension element (rope) with connects the platform to the sea bottom; 314—anchor; 315—electric generator; 316—direction of water flow.

FIG. 40b shows the water low-speed rope rotor for sea and ocean stream (front view). Notations: 317—vertical columns, 318—control devices of a depth (floats).

The installation works in the following way. The water flow 316 presses on the blades 303, moves them to direction 304, and rotates the pulley 310. This pulley is connected to the electric generator 315. The electric generator is located on the floating platform 302 that is connected by the tension element (rope, cable) and the anchor 314 to the sea (ocean) bottom.

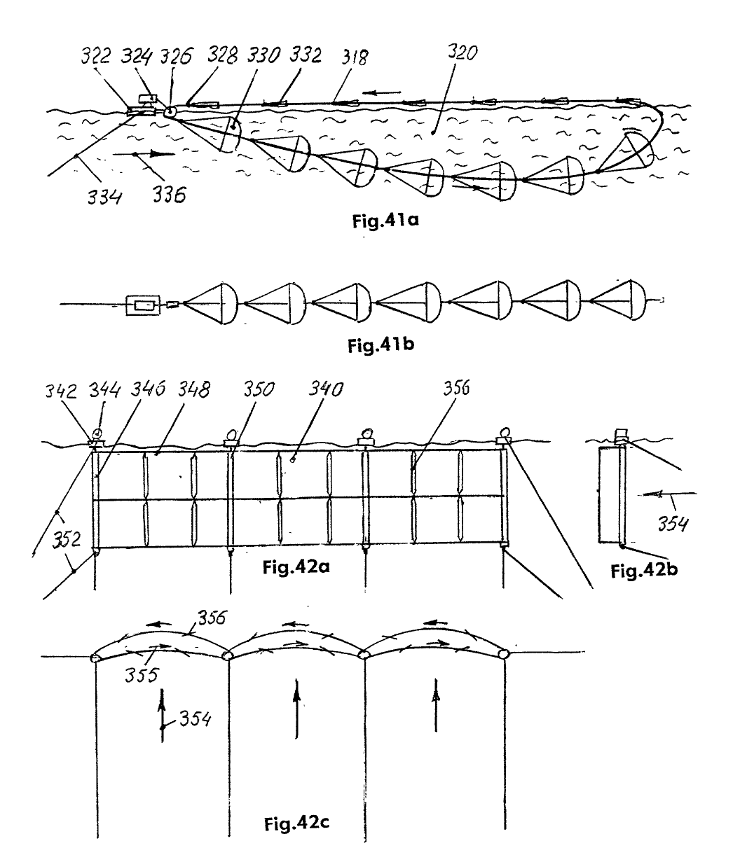

FIG. 41a shows the water drag parachute rope rotor (side view). Notations: 320—installation; 322—floating platform; 324—transfer energy (for example, electric generator); 326—main roller; 328—main rope; 330—parachutes in working position; 332—parachutes in non-working position; 334—rope (tension element) connecting the platform to the sea (ocean) floor; 336—water flow.

FIG. 41b shows the water drag parachute rope rotor (top view).

This sea installation works in the same fashion as with the river installation of FIG. 38. The water flow 336 presses on the parachutes 330 and moves them. The rope 328 rotates the roller (pulley) 326. The pulley 326 rotates the electric generator 324. The electric generator is located on the floating platform 322, that is connected by the rope (cable) 336 to sea (ocean) floor.

FIG. 42a shows a water high-speed rope rotor (front view). Notations: 342—floating platform; 344—transfer energy; 346—columns; 348—main rope; 350—rollers; 352—tension elements (expansions, spreading, stretching) that support said columns, said floating platforms.

FIG. 42b shows the water high-speed rope rotor (side view). Notation: 354—water flow.

FIG. 42c shows the water high-speed rope rotor (top view). Notation: 355—direction of blade motion; 356—blades.

The water high-speed installation works in the following way. The sea flow 354 presses on blades 356 and moves them in direction 355. The rope 348 rotates a pulley that transfers this rotational energy to the electric generator 344. This generator is located on floating platform 342 that is connected to the sea floor by the ropes (tension elements) 352.

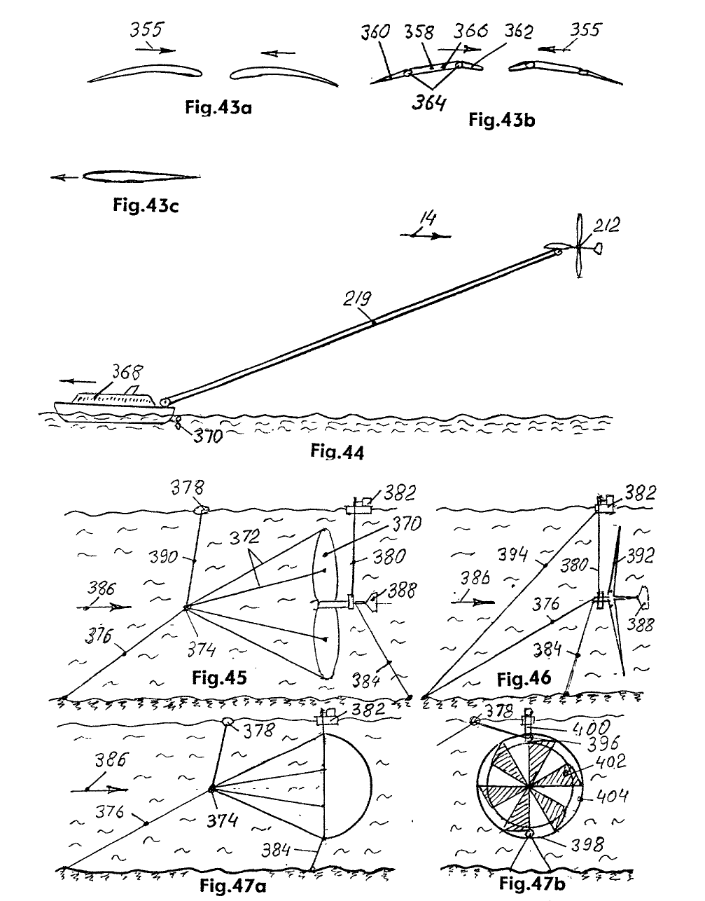

FIG. 43a shows the flexible blade that moves in the right and left directions. Notation: 355—direction of a blade motion.

FIG. 43b shows the positions of the rotated leading and tailing blade edges in the right and left blade movements. Notation: 358—body of blade; 360—tailing edge (flap); 362—hinge leading edge; 364—hinges; 366—blade axis.

FIG. 43c shows the blade controlled form which imposes minimum drag.

The shown controlled forms of the blades provide the most efficiency. This can be applied in the suggested installations.

The FIG. 44 shows the sea ship moved by the propeller wind installation. Notation: 368—sea ship; 370—screw (water) propeller. The ship can be moved in any direction, including a motion against wind.

FIG. 45 shows a water low speed propeller rotor. Notations: 370—propeller rotor; 372—tension member; 374—bearing; 376—tension member; 378—float; 380—energy transferor (transmission); 382—floating platform, electric generator; 384—tension element; 386—stream, flow; 388—stabilizer; 390—support rope (cable).

The rotation of the low speed rotor 370 transfers by the transferor 380 to float platform and electric generator 382. The tension elements 374,384,390 and the float 378 keep the installation in given position.

FIG. 46 shows a water high-speed propeller rotor. Notations: 392—rigid high-speed propeller rotor; 394—tension element.

The rotation of high-speed rotor 392 transfers produced power through the transferor (transmission) 380 to the floating platform and electric generator 382. The tension elements 376, 394, 384 keep the rotor in a given position.

FIG. 47a shows a fabric flexible water low-speed propeller rotor (side view).

FIG. 47b shows the fabric flexible water low-speed propeller rotor (front view). Notations: 396—top roller (pulley); 398—lower roller (pulley); 400—energy transferor (transmission); 402—flexible blade; 404—rotor rim (band, shroud ring).

The flexible rotor 402 transfers its rotation through the rotor rim 404, roller 396 and the transferor (transmission) 400 to the floating platform and electric generator 382. The roller 398 supports the rotor 402 in given position.

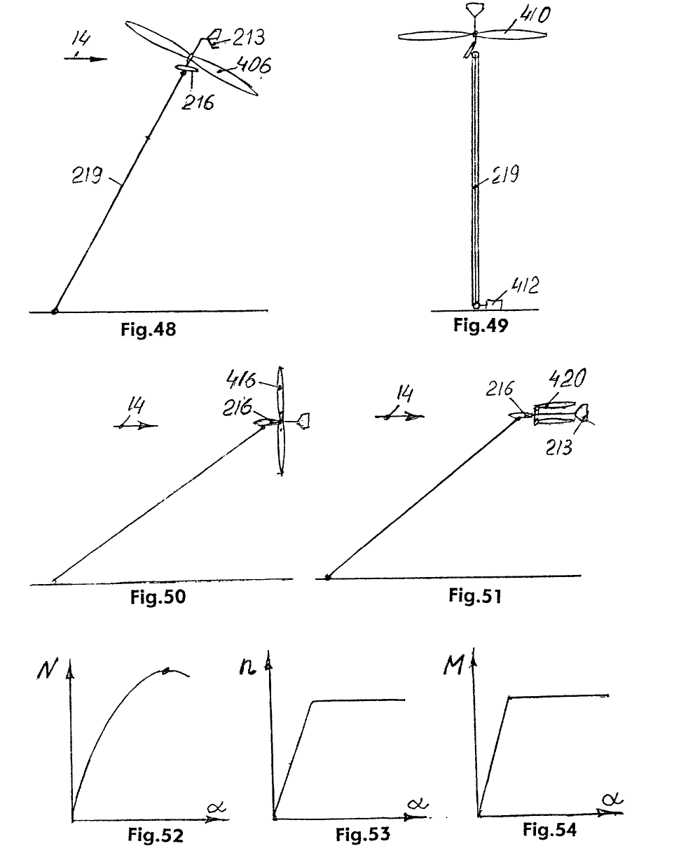

FIG. 48 shows the propeller rotor in slope position when the wind speed is closed to zero. Notation: 406—slope rotor.

In this position the rotor works in similar fashion to the rotor of gyroplane. It has a large area and can provide a big lift force even when the wind speed is low. It lowers the minimum wind speed required to support the rotor system to as low as 1-2 m/s.

FIG. 49 shows the propeller rotor in vertical position rotated by a motor when the wind speed is zero. Notations: 410—propeller rotor in vertical position; 412—motor-generator.

The motor-generator 412 rotates the propeller 410 as helicopter propeller and supports the wind installation while the wind speed is zero. This period of no wind at high altitude is less than one hour per year, on average.

FIG. 50 shows the propeller rotor in the non-working position (no rotation), when the wind is very (too) strong; the rotor blades have zero attack angle. Notation: 416—rotor blade in a stopped position with a blade providing zero lift force.

When the wind is very strong and can possibly destroy the rotor, designers protect the rotor in several different ways. For example, the rotor blades are put into a zero attack angle (no blade lift force), decreasing the aerodynamic force.

FIG. 51 shows the propeller rotor in the non-working position (no rotation) when the wind is very strong; the rotor blades are turned along the rotor axis. Notations: 420—rotor blades in turned (non-working) position.

This is other method of a rotor defense. The propeller can withstand a very strong wind.

FIG. 52 shows a diagram of the control for maximum power by the blade attack angle.

FIG. 53 shows a diagram of the control for constant revolutions by the blade attack angle.

FIG. 54 shows a diagram of the control for constant torque moment by the blade attack angle.

FIG. 55a shows a roller (pulley) for a ribbon transfer rope (side view). Notations: 422—roller; 424—teeth.

FIG. 55b shows a roller (pulley) for a ribbon transfer rope (front view).

FIG. 56 shows the transfer ribbon with holes. Notations: 426—transfer ribbon; 428—holes.

This ribbon and pulley work as a chain (sprocket) transmission, with no sliding between rope and power roller.

### Problems of Launch, Start, Guidance, Control, Stability, and Others

Launching. It is not difficult to launch installations having blades as described in FIGS. 1-17 or installations that have a support wing (FIG. 18,21-37). If the wind speed is more than the minimum required speed (>2-3 m/s), the support wing lifts the installation to the desired altitude.

Starting. All low-speed rotors are self-starting. All high-speed rotors (include ground rotor FIG. 20) require an initial (starting) rotation from the ground motor-generator 12, 230, 294, 344.

Guidance and Control. The control (guidance) of power, revolution speed and torque moment are operated by the turning of blades around the blade longitudinal axis. The control of altitude may be manual or automatic when the wind speed is maximum. Control around the installation axes is effected by stabilizers (elevators), fins, and ailerons (FIGS. 18,21-27,37,44-46).

Stability. Stability of altitude is produced using the length of the main rope. Stability around the blade longitudinal axis is made by stabilizer (see FIGS. 9,21c,22,23,35,50,51) or by special design (FIGS. 10,11,15-19,38,41). Rotor directional stability in line with the flow is created by fins (FIGS. 1,9,18,21,23-27,44-51) or by special design (FIGS. 1,10,18,19,38,39,41,42,45-47). When installation has the support wing rigidly connected to the rotor, the stability is also attained by the correct location of the center gravity of the Installation (system rotor-wing) and point of connection at the top end of the main rope (cable) and the tension elements. The center of gravity and connection point must be located within a relatively narrow range 0.2-0.4 of the average aerodynamic chord of the support wing (for example, see FIGS. 25, 37). There is the same requirement for the additional support wings such as 20 (FIG. 2a) or 199 (FIG. 21a,23a). The center of gravity of the wing and the top end of rope must be connected in interval 0.2-0.4 of average aerodynamic wing chord.

Torque moment is balanced by transmission and wing ailerons (see all figs.).

The wing lift force (stress of main rope and installation local height) is regulated by the wing flap (for example, see description to FIG. 27) or blade stabilizer.

The location of the installation at a given point of the atmosphere is provided by tension elements show on FIG. 12 (126), FIG. 24 (237), FIG. 42 (352),FIGS. 45-47 (376, 390, 384). These tension elements provide a turning capability for the installation of approximately ±450 degrees in the direction of flow (see. FIGS. 12,24).

Zero wind speed. The required minimum wind-speed (when a rotor or support wing cannot support the installation weight at atmosphere) for most suggested installation designs is about 2 m/s. The probability of this minimum at high altitude is very small (less 0.001). This minimum may be decreased by using the turning propeller worked as the gyroplane (autogiro) rotor (see FIG. 48). If the wind speed equals zero, the rotor can be supported in the atmosphere by an air balloon (dirigible) as it is shown on FIG. 27a or a propeller rotated by the ground power station as it is shown on FIG. 49. The rotor may also land on the ground and start again in short time when the wind speed attains the minimum speed.

A gusty wind. Big pulsations of wind (power) can be smoothed out by storage of energy [inertial fly-wheels, FIG. 25b, (12-1)].

The suggested Method and Installations for utilization a flow (stream) energy has big advantages compared with conventional, current methods:

### Air Installations

1. This installation allows the collection of energy from a big area —tens and even hundreds of times more than conventional wind (water) turbines. This is possible because an expensive tower is not needed to fix our rotor in space. Our installation allows the use of a rotor with a very big diameter, for example 100-200 and more meters.

2. Our wind installation can be located at high altitude 100 m-14 km. The wind speeds are 2-4 times faster and more stable at this high altitude compared to the altitude of conventional windmills (10 meters). Especially is certain geographic areas known to meteorologists, wind flows (streams) at such high altitudes have a continuous, or permanent nature. Since wind power increases at the cube (third power) of wind speed, wind rotor power increases by 27 times when wind speed increases by 3 times.

3. Our installations produce more power by thousands times compared to the typical current wind ground installation (see point 1,2 above).

4. Our installations are located at altitude. They do not require ground space. They can be disposed near places that need energy, for example, near a town, city, or plant. It is not necessary to have long, expensive, high-voltage transmission lines, or high-voltage substations.

5. Our installation does not impair environment quality.

6. Our installation is cheaper than conventional wind installation by some times, or many times for large installations, in part because our installation does not need an expensive tower.

7. Our installation can be easy relocated in another place. The installation can be packed into a small volume and relocated by tracks to other place. This takes 1-2 days.

8. Our ground installations have large power capacity because of their large working area. It is cheaper than conventional windmills of the same power.

9. Wind energy is free.

10. There is no noise because the rotor has a low speed and is located at high altitude.

On of the main innovations of the given invention is the rope transfer (transmission) of energy from the wind rotor located at high altitude to the electric generator located on ground. All previous attempts to dispose the generator near rotor and connect it to ground by electric wires were not successful because the generator and wires are heavy.

Another important innovation is the rope (cable) rotor. The rope system allows the utilization of a cheap rotor having a large diameter (large useful area).

### Water installation

1. Water installations FIG. 38,39 are significantly less expensive than existing systems because they do not require a dam.

2. The installations FIGS. 40,41,42,45-47 can use ocean, sea or stream energy. Author is not aware of any water installations that use sea or ocean stream energy.

3. These installations are not expensive and produce much energy.

### Some Information About Wind Energy

The power of a wing engine strongly depends on the wind speed (to the third power, or cubed). This means that comparisons will only be correct if we will compare installations for the same wind speed. The industry claims that their wind engines (rotors) can withstand wind speed of up to 13 m/s and more. For comparison purposes, their power ratings must be recalculated (decreased) to the common wind speed V=6 m/s for an altitude H=10 m (it is very expensive to locate a ground wind engine at higher altitude).

If the altitude is decreased, the wind speed decreases. For example, the wind speed at altitude H=1000 m is more than two times that of the wind speed at an altitude of H=10 m. This means that the power of the installation increases by a factor of eight times. Unfortunately, modern industry cannot build a tower with a height of 1000 m. Regardless, this would be very expensive.

High altitude wind has another important advantage. It is stable and constant. This is true practically everywhere.

Especially in the troposphere and stratosphere, the wind currents are powerful and permanent. For example, at an altitude of 5 km, the average wind speed is about 20 M/s, at altitude 10-12 km it may reach 40 m/s (at latitude of about 20-35° N).

There are permanent jet streams at high altitude. For example, at H=12-13 km and about 25° N latitude. The average wind speed at the it core is about 148 km/h. The most intensive portion, with a maximum speed 185 km/h latitude 22°, and 151 km/h at latitude 35° in North America. On a given winter day speeds in the jet core may exceed 370 km/h for a distance of several hundred miles along the direction of the wind. Lateral wind shears in the direction normal to the jet stream may be 185 km/h per 556 km to right and 185 km/h per 185 km to the left. The wind speed V=40 m/s at altitude H=13 km provides 64 times more energy than conventional wind speeds of V=6 m/s at an altitude of H=10 m.

This is a gigantic renewable free energy source.

Reference: Science and Technolody, v.2, p.265.

The primary innovations in the given invention is locating the rotor at high altitude, and the rope transferor (transmission) system to transfer mechanical energy from the rotor to the ground power station (because the heavy electric generator and electric wire cannot be supported at height).

The critical factor for this transferor is weight of transfer (transmission) rope (cable), and its air drag.

Most engineers and scientists would think that it is impossible to develop a rope transferor (transmission) using a long cable system. Twenty years ago, the mass and air drag of the required cable would not allow this proposal to be possible. However, today's industry widely produces artificial fibers, which have tensile strengths 3-5 times more than steel and densities 4-5 times less then steel. There are experimental fibers which have tensile strengths 30-100 times more than a steel and densities 2 to 5 times less than steel. For example, in the book “Advanced Fibers and Composites,” by author Francis S. Galasso, Gordon and Branch Science Publisher, 1989, p.158, there is a fiber (whisker) C_{D}, which has a tensile strength of H=8000 kg/mm² and density (specific gravity) of D=3.5 g/cm³. If we take an estimated strength of 7000 kg/mm² (H=7×10¹⁰ n/m², D=3500 kg/m³), then the ratio is D/H=0.05×10⁻⁶ or H/D=20×10⁶. Although the described (1976) graphite fibers are strong (H/D=10×10⁶), they are at best still ten times weaker than theory predicts. The steel fiber has a tensile strength of 5000 MPA (500 kg/sq.mm), the theoretical limit is 22,000 MPA (1987); the polyethylene fiber has a tensile strength 20,000 MPA, the theoretical limit is 35,000 MPA (1987). The very high tensile strength has new artificial material—nanotubes.

Apart from unique electronic properties, the mechanical behavior of nanotubes also has provided excitement because nanotubes are seen as the ultimate carbon fiber, which can be used as reinforcements in advanced composite technology. Early theoretical work and recent experiments on individual nanotubes (mostly MWNT's) have confirmed that nanotubes are one of the stiffest materials ever made. Whereas carbon-carbon covalent bonds are one of the strongest in nature, a structure based on a perfect arrangement of these bonds oriented along the axis of nanotubes would produce an exceedingly strong material. Traditional carbon fibers show high strength and stiffness, but fall far short of the theoretical, in-plane strength of graphite layers (an order of magnitude lower). Nanotubes come close to being the best fiber that can be made from graphite structure.

For example, whiskers from Carbon nanotube (CNT) have a tensile strength of 200 Giga-Pascals and a Young's modulus over 1 Tera Pascals (1999). The theory predicts 1 Tera Pascals and a Young's modules of 1-5 Tera Pascals. The hollow structure of nanotubes makes them very light (the specific density varies from 0.8 g/cc for MWNT's up to 1.8 g/cc for MWNT'S, compared to 2.26 g/cc for graphite or 7.8 g/cc for steel).

Specific strength (strength/density) is important in the design of our system; nanotubes have values at least 2 orders of magnitude greater than steel. Traditional carbon fibers have a specific strength 40 times that of steel. Since nanotubes are made of graphitic carbon, they have good resistance to chemical attack and have high thermal stability. Oxidation studies have shown that the onset of oxidation shifts by about 100° C. to higher temperatures in nanotubes compared to high modulus graphite fibers. In a vacuum, or reducing atmospheres, nanotube structures will be stable to any practical service temperature.

These fibers are cheap. They are widely used in tires and everywhere. The price of SiC whiskers produced by Carborundum Co. with σ=20,690 Mpa and γ=3.22 g/cc was $440/kg in 1989. The market price of nanotubes is also too high presently (˜$200 per gram)(2000). In the last 2-3 years, there have been several companies that were organized in the US to produce and market nanotubes. It is anticipated that in the next few years, nanotubes will be available to consumers for less than US $100/pound.

Below, the author provides a brief overview of recent research information regarding the proposed experimental (tested) fibers. In addition, the author has also solved additional problems, which appear in these projects and which can appear as difficult as the proposed technology itself. The author is prepared to discuss the problems with serious organizations which are interested in researching and developing related projects.

### Data Which Can be Used for Computation

Some industrial fibers and experimental whiskers are presented in Table #1.

TABLE 1

| | Tensile | | | | |
|---|---|---|---|---|---|
| Material | of strength | Density | | | Density |
| Whiskers | kg/mm^{2 or GPa} | g/cc | Fibers | MPa | g/cc |
| A1B12 | 2650 | 2.6 | QC- | 6200 | 1.95 |
| B | 2500 | 2.3 | TM9 | 6000 | 1.79 |
| B4C | 2800 | 2.5 | Thorael | 5650 | 1.81 |
| TIB2 | 3370 | 4.5 | Allien 1 | 5800 | 1.56 |
| graphite | 1.97 GPa | 1.67 | Allien 2 | 3000 | 0.97 |
| SiC | 13,8-41.4 GPa | 3.22 | | | |

1. Industrial fibers with σ=500 kg/mm², γ=1800 kg/m³, and σγ=2,78×10⁶ are used in our projects (admissible σ=200-250 kg/mm²).

Notes: 1. Advanced Fibers and Composite, by F. S. Galasso, 1989.

2. Carbon and High Performance Fibers, Directory, 1995.

3. Concise Encyclopedia of Polymer Science and Engineering, Ed. J. I. Kroschwitz, 1990.

4. Carbon Nanotubes, by M. S. Dresselhaus, Springer, 2000.

### Brief Theory of Estimation or Wind Energy and Suggested Installations

### Rotor

Power of energy N [Watt, joules/s]

N=0.5ηρAV³[W] (1)

where: A—front area of rotor [m²].

ρ—density of flow, ρ=1.225 kg/m3 for air at sea level altitude H=0;

ρ=0.7364 at altitude H=5 km; ρ=0.4135 at H=10 km.

V—annual average wind speed;

η—efficiency coefficient.

The coefficient of efficiency equals η=0.15-0.35 for low speed rotors (ratio of blade tip speed to wind speed equals λ≈1); θ=0.35-0.5 for high speed rotors (λ=5-7). The Darrieus rotor has η=0.35-0.4. The propeller rotor has η=0.45-0.50. The theoretical maximum equals η=0.67.

The wind speed increases with height

V=(H/Hₒ)^{α}Vₒ, (2)

where Hₒ=10 m—standard altitude;

H—altitude [m];

Vₒ—wind speed at standard altitude [m/s] (Vₒ=6 m/s);

α=0.1-0.25 exponent coefficient. One depends from surface ronghness.

When terrain surface is water, α=0.1; when terrain surface is suburb and woodlands α=0.25

Power increases with height as the cube of wind speed

N=(H/Hₒ)^{3α}Nₒ, (3)

where Nₒ is power at Hₒ.

The drag of rotor equals

Dᵣ=N/V (4)

The lift force of wind is

L_{y}=0.5C_{y}ρV²A_{w} (5)

where C_{y} is lift coefficient (maximum C_{y}≈2.5), A_{w} is area of wing.

The drag of wing is

D=0.5CₓρV²A_{w}, (6)

where Cₓ is drag coefficient (maximum Cₓ≈1.2).

Optimal speed of for parachute rotor equals ⅓V. Theoretical maximum of efficiency coefficient is 0.5

The annual energy produced by flow installation equals

E=8.64N [kWh]. (7)

### Rope Transferor

Cross-section area of rope (cable) S [mm²] is

S=P/vσ, (8)

where v—speed of rope [m/s];

P—power;

σ—tensile stress of rope [n/mm²].

Weight of rope is

Wᵣ=SLγ, (9)

where L—length of rope [m];

γ—specific density of rope [kg/m³]

Produce cost of kWh

c=(M+I/k)/E, (10)

where M—maintenance [$];

I—cost of Installation [$];

k—life time (years).

Annual profit

F=(C−c)E, (11)

where c is retail price of 1 kWh.

Needed area of the support wing is

A_{w}=(ηA· sin θ)/C_{y}. (12)

where θ is angle between support cable and horizon.

The wing area is served by aileron for balance of rotor (propeller) torque moment

Aₐ=(ηAR)/(λ·ΔC_{y,a}·r), (13)

where ΔC_{y,a} difference of lift coefficient between left and right ailerons;

r is distance from center of wing and center of aileron;

R is radios of rotor.

The minimum wind speed when the installation is supported by wing

Vₘᵢₙ=(2W/C_{y,max}ρA_{w})^{0.5} (14)

where W is weight air part of the Installation (rotor+cables).

If a propeller rotor is used as the gyroplane (slide) rotor (FIG. 48 or 27d), this speed will be less in 2-2,5 times.

If wind speed equal zero, the needed power for supporting propeller rotor working as helicopter rotor is

Nₛ=W/k [kW], (15)

where W—weight installation (rotor+cables) [kg], k≈5-12 [kg/kW].

The specific weight of energy storage (flywheel) may be estimated by equations

Eₛ=σ/2γ[MW/kg]. (16)

For example, if σ=200 kg/sq.mm, γ=1800 kg /M³, then Eₛ=0.56 MW/kg or Eₛ=0.15 kWh.

### Project 1

### High-Speed Air Propeller Rotor (FIG. 27)

For example, let us consider a diameter of rotor 100 m (A=7850 m²), altitude H=10 km (ρ=0.4135 kg/cm), speed of wind flow V=30 m/s efficiency coefficient η=0.5, cable tensile stress σ=200 kg/mm² Then the power is N=22 MgW [formula (1)]. This energy is sufficient for town with population 250,000. The rotor drag is Dᵣ=73 tons, cross-section of the main cable area is S=73/0.2=365 mm², cable diameter equals d=21.5 mm; cable weight is W=13 tons. Cross-section of the transfer rope is S=36.5 mm², d=6.8 mm, W=491 kg for rope speed v=300 m/s.

The required wing size is 20+100 m (C_{y}=1), wing area served by ailerons is 820 sq.m. If C_{y}=2, the minimum speed is 2 m/s.

The Installation will produce energy E=190 GWh.

If the installation costs $200K, has a useful life (useful life) of 10 years, and requires maintenance of $50K per year, the production cost is c=0.37 cent per kWh, the profit is $26 millions per year.

### Project #2

### Air Low Speed Wind Engine With Free Flying Rope Flexible Rotor (FIGS. 1-2)

Let us consider the size of rope rotor width 50 m, a rotor diameter 1000 m, then the work area is A=50×1000=50,000 sq.m.

The angle rope to a horizon is 70°. The angle of ratio lift/drag is about 2.5°.

The average conventional wind speed at altitude H=10 m is V=6 m/s. It means that the speed at the altitude 1000 m is 11.4-15 m/s. Let us take average wind speed v=13 m/s at altitude H=1 km.

The energy of flow is

N=0.5·ρV³A cos 20°=0.5·1.225·13³·1000·50·0.94=63 MgW.

If the coefficient efficiency is η=0.2 the power of installation is

η=0.2×63=12.5MgW.

The energy 12.5 MgW is enough for a town with population 150,000. If we decrease our Installation to a 100×2000 m the power decreases approximately by 6 times (because the area decreases by 4 times, wind speed reaches 15 m/s at more altitude. It will be 75 MgW. This is enough for town with population about 1 million people.

If the average wind speed is different for given location the power for the basis installation will be: V=5 m/s N=7.25 MgW; V=6 m/s N=12.5 MgW; V=7 m/s N=19.9 MgW; V=8 m/s N=29,6 MgW; V=9 m/s N=42.2 MgW; V=10 m/s N=57.9 MgW.

### Economical Efficiency

Let us assume that the cost our installation is $1 million. According to the book “Wind Power” by P. Gipe [1], the conventional wind installation with diameter rotor 7 m costs $20,000 and for average wind speeds of 6 m/s has power 2.28 kW, producing 20,000 kWh per year. To produce the same amount of power as our installation using conventional methods, we would need 5482 (12500/2.28) conventional rotors, costing $110 million. Let us assume that our installation has a useful life of 10 years and cost $50,000/year for maintenance. Our installation produces 109,500,000 kWh energy per year. Initial capital costs will be approximately 150,000/109,500,000 =$0.14/kWh. The retail price of 1 kWh energy in New York City is $0.15 now. The revenue is 16 millions. If the cost of maintenance and salary is 6 millions, the profit is 10 millions per year.

### Estimation Some Technical Parameters

The rope diameter for an admissible fiber tensile strange σ=200 kg/sq.mm is

S=200010.2=10,000 mm², d=113 mm.

The weight of rope for density 1800 kg/m³ is

W=SLγ=0.01·2000·1800=36 tons.

Let us assume that the weight of 1 sq.m of blade is 0.2 kg/m² and the weight of 1 m of bulk is 2 kg. The weight of the 1 blade will be 0.2×500=100 kg, and 200 blades are 20 tons. If the weight of one bulk is 0.1 ton, the weight of 200 bulks is 20 tons.

The total weight of main parts of the installation will be 94 tons. We assume 100 tons for purposes of our calculations.

The minimum wind speed when the flying rotor can supported in the air is (for C_{y}=2)

V=(2W/C_{y}ρS)^{0.5}=(2·100·10⁴/2·1.225·200·500)^{0.5}=2.86 m/s

The probability of the wind speed falling below 3 m/s when the average speed is 12 m/s, is zero, and for 10 m/s is 0.0003. This equals 2.5 hours in one year, or less than one time per year. The wind at high altitude has greater speed and stability than near ground surface. There is a strong wind at high altitude even when wind near the ground is absent. This can be seen when the clouds move in a sky on a calm day.

### Project #3

### Ground Wind High Speed Engine (FIG. 20)

Let us consider the ground rope flexibility size 500×500×50 meters. The work area is 500×50×2=50,000 sq.m. The tower is 60 meter tall, the flexible rotor located from 10 m to 60 m. If the wind speed at altitude 10 m is 6 m/s, that is 7.3 m/s at altitude 40 m.

The theoretical power is

Nₜ=0.5ρV³A=0.5·1.225·7.3³·5·10⁴=11.9 MgW.

For coefficient of the efficiency equals 0.45 the useful power is

N=0.45·11.9=5.36 MgW.

For other wind speed the useful power is: V=5 m/s N=3.1 MgW; V=6 m/s N=5.36 MgW; V=7 m/s N=8.52 MgW; v=8 m/s N=12.7 MgW; V=9 m/s N=18.1 MgW; V=10 m/s N=24.8 MgW.

### Economic Estimation

In this installation the rotor will be less expensive than previous installations because the high-speed rotor has a smaller number of blades and smaller blades (see technical data below). However this installation needs 4 high (60 m) columns. We estimate the cost to build and install the installation at $1 million with a useful life of 10 years. The maintenance is projected at about $50,000 year.

This installation will produce E=5360 kW×8760 hours=46.95 MkWh energy (with annual average wind-speed V=6 m/s at H=10 m). The cost of 1 kWh is 150,000146,950,000=0.4 cent/kWh. If the selling price is $0.15/kWh and delivery cost 30%, the profit is $0.10 per kWh, or $4.7 million per year.

### Estimation of Some Technical Parameters

The blade speed is 6×7.3=44 m/s. The distance between blades is 44 m. The number of blade is 4000:44=92.

### Project #4

### High Speed Air Flexible Rotor (FIG. 23)

Let us consider a rotor with diameter of 100 m, a length of 200 m 20,000 sq.m). The wind speed at altitude 10 m, is V=6 m/s, at H=1000 m is 13 m/s. The full wind energy is 13,46 MgW. Let us take the efficiency coefficient 0.35, then the power of the Installation will be N=4.7 MgW. The change of power from wind speed is: V=5 m/s N=2.73 MgW; V=6 m/s N=4.7 MgW; V=7 m/s N=7.5 MgW; V=8 m/s N=0.11.4 MgW; V=9 m/s N=15.9 MgW; V=10 m/s N=21.8 MgW.

At an altitude of H=13 km with air density 0.2666 and wind speed V=40 m/s, the given installation will produce N=30 MgW energy.

### Estimation of Economical Efficiency

Let us estimate the cost of the Installation at $1 million, a useful life of 10 years, and maintenance of $50,000/year. Our installation will produce E=41 millions kWh per year (for wind speed 6 m/s at altitude 10 m). The prime cost will be 150,000/41,000,000=0.37 c/kWh. If the customer price is $0.15/kWh and profit from 1 kWh is $0.10/kWh the profit will be $4.1 million per year.

### Estimation of Technical Parameters

The blade speed is 78 m/s. Numbers of blade is 4. Number of revolution is 0.25 revolution per second. The size of blade is 200×0.67 m. The weight of 1 blade is 1.34 tons. The total weight of the Installation is about 8 tons. The internal wing has size 200×2.3 m. The additional wing has size 200×14.5 m and weight 870 kg. The cross-section area of the rope transmission with an altitude of H=1 km is 300 sq.m, the weight is 1350 kg.

### Project #5

### Low Speed Air Drag Rotor (FIG. 18)

Let us consider a parachute with a diameter of 100 m, length of rope 1500 m, distance between the parachutes 300 m, number of parachute 3000:300=10, number of worked parachute 5, the area of one parachute is 7850 sq.m, the total work area is A=5×7850=3925 sq.m. The full power of the flow is 5.3 MgW. If coefficient of efficiency is 0.2 the useful power is N=1 MgW. For other wind speed the useful power is: V=5 m/s N=0.58 MgW; V=6 m/s N=1 MgW; V=7 m/s N=1.59 MgW; V=8 m/s N=2.37 MgW; V=9 m/s N=3.375 MgW; V=10 m/s N=4.63 MgW.

### Estimation of Economical Efficiency

Let us take the installed cost of the Installation $0.5 million, a useful life of 10 years and maintenance of $20,000/year. The energy produced in one year is E=1000×24×360=8.64 million kWh. The basic cost of energy is 70,000/8640,000=0.81 c/kWh.

### The Some Technical Parameters

The rope speed will be 4.33 m/s. The thrust is 23 tons. The rope diameter is 12 mm, if the tensile stress is 200 kg/sq.mm (composed fiber). The full weight of the installation is 4.5 tons. The support wing has size 25×4 m.

### The Project #6

### Big Air Propeller at Altitude H=1 km (FIG. 24 or 27)

Let us consider a propeller diameter of 300 m, the work area A=7·10⁴ m², altitude H=1 km, wind speed at this H=1 km is 13 m/s. The average speed of blade end is 78 m/s.

The full power of the flow is 94.2 Mgw. If coefficient of efficiency is 0.5 the useful power is N=47.1 MgW. For other wind speed the useful power is: V=5 m/s N=23.3 MgW; V=6 m/s N=47.1 MgW; V=7 m/s N=74.9 MgW; V=8 m/s N=111.6 MgW; V=9 m/s N=159 MgW; V=10 m/s N=218 MgW.

### Estimation of Economical Efficiency

Let us assume that the cost of the Installation is $3 million, a useful life of 10 years and maintenance of $100,000/year. The energy produced in one year is E=407 GWh. The basic cost of energy is $0.01/kWh.

### The Some Technical Parameters

### Altitude H=1 km

The drag is about 360 tons. Ground connection rope has cross-section area 1800 sq,mm, d=48 mm, and weight 6480 kg. The need wing is 60×300 m. The wing area served by aileron (balance of torque moment) is 6740 sq.m.

If the transmission rope speed will be 300 m/s, the cross-section area of transmission rope will be 76 sq.mm and the rope weight is 137 kg (composed fiber).

### Altitude H=13 km

At altitude H=13 km the air density is 0.2666, the speed is V=40 m/s. The power (for efficiency coefficient 0.5) is 301.4 MgW. The drag of propeller is about 754 tons. The connection rope has cross-section area 3770 sq.m, a diameter of rope is d=70 mm and weight 176 tons. The transmission has the gross section area 5 sq.c and weight 11.7 tons.

The installation will produce E=2604 Gwh. If the installation will cost $5 millions, maintenance is $200,000/year and the cost of 1 kwh will be $0.0097/kwh.

### The Project #7

### The Water River Lower Speed Drag Installation (FIG. 38)

Let us assume that we have a river of width 500 m, depth 5 m, and water speed 2 m/s. This speed will be if the river has the slope 1.15 degree, or 0.2 m on 10 m (or 20 m on 1000 m). The full power will be 0.5×1000×8=10 MgW. If coefficient efficiency is 0.25 we will have the power 2.5 MgW from one blade. If the water speed is 1 m/s the power is 0.3 MgW (slope is 0.05 m to 10 m) from 1 blade. If the water speed is 3 m/s the power is 8.4 MgW (slope is 0.45 m to 10 m) from 1 blade. If the river has this slope (1.15 degree, speed 2 m/s) on length 1000 m the installation has 100 blades, the total power is 250 MgW.

### Estimation Economical Efficiency

Let us assume an Installation costs $2 million to install, has a useful life of 10 years and a maintenance cost of $200,000/year. The Installation will produces energy H=250 Mgw×24×360=2,160,000,000 kWh. The prime cost will be c=400,00012,160,000,000=0.0185 c/kWh.

### Estimation of Some Technical Parameters

The size of 1 blade is 500×5=2500 sq.m, the thrust of 1 blade for water speed 2 m/s is 500 tons. The speed of the blade is ⅔=0.66 m/s.

### Project #8

### The Sea Stream (Gulf Stream) Drag Installation (FIG. 41)

The “World Book” v.8, p.418 informs that the Gulf Stream near Florida has a speed of up to 2.58 m/s and a depth up to 790 m. Let us assume the following parameters: speed 2 m/s, parachute diameter 100 m, distance between two parachute is 250 m, length of line is 2500 m, number of working parachutes is 20 and the efficiency coefficient is 0.2. Then the power of one parachute will be 3.14 MgW, the 10 parachutes −31.4 MgW.

### Economical Efficiency

Let us assume an installation cost of $1 million, a useful life of 10 years and maintenance costs of $50,000/year. This installation will produce E=31.4×24×360=271,296,000 kWh energy with basic cost 150,000/271,296,000=$0,055/kWh. If the customer price is 0.15 $/kWh and the profit margin is $0.1/kWh, the total profit is $27.1 million per year.

### Project #9

### The Gulf Stream Low Speed Installation (FIG. 40)

Let us consider a total size of 1000 m and the hight of the blades 100 m and a coefficient of efficiency 0.2. The power will be 40 MgW. The Installation will produce E=345,600,000 kWh energy. If the installation cost is $2 million, the useful life is 10 years and the maintenance cost is $100,000/year, the prime cost 1 kWh is 0.087 c/kWh, the profit is $34.5 million per year.

### Project #10

### Gulf Stream High Speed Installation (FIG. 42)

Let us consider a total size of 1000×100 m., water speed of 2 m/s and an efficiency coefficient of 0.45. The power produced will be 90 MgW. The installation will provide E=777,600,000 kWh energy. If the installation cost is $2 million, the useful life is 10 years and the maintenance is $100,000/year, the prime cost of 1 kWh is $0.038/kWh and the profit is $77.7 million per year.

### Project #11

### Sea Ship Moved by Wind Engine (FIG. 44)

Let us consider a rotor diameter d=50 m (A=1962 sq.m), altitude H=500 m, wind speed Vₒ=6 m/s), at Hₒ=10 m (at H=500 m, V=9 m/s), η=0.5. Then the power of the wind engine is N=440 kW. If the rotor diameter is d=100 m, then the power is N=1760 kW. This power does not depend on wind direction. The ship can travel at practically the same speed in any direction, regardless of wind direction.

### REFERENCES

1. “Wind Power”, by Paul Gipe, Chelsea Green Publishing Co., Vermont. 1993.

2. “Fundamentals of Wind Energy”, by N. P. Cheremisinoff, Ann Arbor Science, 1978.

3. “Wind energy Systems”, by G. Johnson, 1984.

4. [symbol] [symbol] , [symbol] [symbol] , [symbol] , [symbol] , 1972 (“Wind-energy aggregates”, Moscow, Russian).

I claim:

1. An Method of Utilization a flow (stream) energy comprising of steps:
(a) connecting lift-drag devices to a rotor;
(b) connecting said rotor to a ground, whereby a connection rope;
(c) disposing energy station at the Earth surface;
(d) connecting said rotor to said energy station whereby rope transferor;
(e) disposing said rotor to flow as a free-fly (free-float) rotor;
(f) transferring a rotate energy from said rotor to said energy station whereby said rope transferor;
(g) controlling altitude and power of said rotor.

2. The Method of Utilization a flow energy as recited in claim 1 comprising at least one of the following steps:
(a) making a closed loop rope;
(b) using blades as said lift-drag devices;
(c) connecting said lift-drag devices to said rope and getting flexible rope rotor with parallel blades;
(d) connecting said lift-drag devices by one end to a rigid rotor axis (shaft) and getting a propeller;
(e) disposing said rope-flexible blade rotor to air at a high altitude up 14 km;
(f) supporting said rope rotor whereby a lift force of said blades;
(g) supporting said rope rotor whereby a lift force of a rotor wing connected to said rotor;
(h) supporting said rotor whereby an air balloon;
(i) supporting said rotor whereby a self-support slope propeller;
(j) supporting said connection rope whereby a connection rope wing;
(k) supporting said rope transferor whereby a transferor wing;
(l) connecting said rope rotor to a surface whereby columns;
(m) connecting said rope rotor to a surface whereby rollers;
(n) connecting said rope rotor to said energy station whereby at least one of the following devices: rollers, rope transferor, rope pulleys, spools, gear boxes, clutches, reverse mechanism;
(o) disposing said rotor to a water flow;
(p) controlling said blades and said rotor whereby at least one of the following devices: stabilizer, elevator, flaps, ailerons, fin, turn mechanisms;
(q) controlling said rotor support wings whereby at least one of the following devices: wing stabilizer, elevator, ailerons, flaps, fin, and control devises;
(r) pressing said rotor and transfer ropes to said rollers whereby additional press rollers;
(s) changing revolutions said rotor roller before transferring of energy to said power station whereby a rotor gear box;
(t) using parachutes as said drag devices connected to said rotor rope in two point: end of parachute cord (shroud lines) and a canopy top of said parachute;
(u) connecting said blade in one point of shaft and connecting to propeller rotor;
(v) disposing axis of said propeller in a direction of said stream;
(w) connecting said blade in several points to central bulk whereby ropes and getting Darrieus form of rope rotor;
(x) disposing said Darrieus rotor and their bulk in horizontal position in perpendicular direction into said flow;
(y) making said rope from artificial fibers, whispers, nanotubes;
(z) making said wing, blades, pulleys, rollers from composed material;
(aa) making said parachutes from artificial filaments;
(bb) lifting said rope rotor to said high altitude whereby said blades, wing, and variable rope connection and rope transferor;
(cc) initial rotation said rotor whereby an engine located at surface and said transferor;
(dd) making said transfer rope in a ribbon form;
(ee) making said transfer rope in a ribbon form with holes and pulleys with teeth (cogged rollers).

3. The method Utilization a flow energy as recited in claim 2 comprising
at least one of the following steps:
(a) lifting said rotor whereby said rotor blades;
(b) lifting said rotor whereby said rotor support wing;
(c) lifting said propeller rotor whereby said power station;
(d) starting said rotor whereby self starting;
(e) starting said propeller rotor whereby said power station;
(f) controlling (guiding) said propeller by turning said blades around their longitudinal axis;
(g) controlling said blades such they give a maximum torque moment;
(h) opening said parachutes when they are moving in direction of stream (flow) and packing (closing) them when they move against a direction of said stream;
(i) mating said blades of said propeller from mobile sections which can be turned around on longitudinal blade axis;
(j) controlling said propeller sections such they give a maximum torque moment whereby at least one of the following devices: section stabilizer, elevator, flaps;
(k) making mobile blades of said Darrieus rotor;
(l) controlling angle of said mobile Darrieus blades such they give enough lift force for supporting said rotor at given altitude when they are in vertical position and maximum torque when they are in horizontal position whereby turning them around blade on a longitudinal axis;
(m) making propellerlet at ends of said propeller rotor;
(n) controlling said propellerlet such they give enough average lift force for support propeller at given altitude when said blade is in vertical position, and minimum average drag when said blade is in horizontal position;
(o) controlling lift force of said support wings thereby that their average lift force is equal a weight of air pats of said installation;
(p) controlling said blades thereby that forces are below than admissible load in rotor and rope;
(q) locating a center of gravity at a rigid system of said rotor—said rotor support wing in relatively interval 0.2-0.4 an average aerodynamic chord of said support rotor wing;
(r) connecting a top end of said connection rope to said center of gravity;
(s) spooling said transfer energy rope from one spool to other across said rotor and a reverse mechanism;
(t) changing direction of spooling whereby said reverse mechanism when a spool is filled
(u) turning said propeller blades to a parallel position of said rotor axis when a wind speed is more then an admissible value;
(v) landing said rotor whereby decreasing of said rotor lift forces for inspecting and repairing.

4. An Installation used the Method Utilization of flow energy comprising:
(a) rotor composed from lift-drag devices and disposed to a stream (flow);
(b) connection rope which connects said rotor to ground surface;
(c) energy station located on said surface and connected to said rotor;
(d) rollers connected said rotor to said energy station;
(e) an energy rope transferor (transmission) connected said rotor to said energy station;
(f) control devices which guides said rotor.

5. The Installation as recited in claims 4 further includes
at least one of the following devices:
(a) a closed-loop ropes;
(b) lift-drag devices connected to said closed-loop ropes, they form a flexible rope rotor together with said closed-loop ropes;
(c) blades used as said lift-drag devices and connected to said rotor;
(d) support rotor wings connected to said rotor and supported said flexible rope-blade rotor at altitude;
(e) connection rotor rope connected said rotor to a ground;
(f) support connection wing connected to said connection rope and supported said connection rope;
(g) energy convector such as electric generator, electric engine-generator;
(h) rotor reductor (transmission) of revolutions of said rope rollers disposed at said rotor;
(i) station reductor of revolutions of said transfer rope disposed at said energy station;
(j) rotor rollers connected to said rotor;
(k) transmission rollers connected to energy rope transferor;
(l) additional press rollers connected to said rollers for improving connection said ropes to said rollers;
(m) control devices such as stabilizer, elevator, flaps, fin, propellerlets connected to said blades and wing;
(n) parachutes connected to said rope rotor and used as said drag devices;
(o) rotor pulley mechanism connected to said rope rotor and used for a change of a diameter of said rope rotor;
(p) pulley mechanism of said transferor which can change a length of rope transferor;
(q) rotate platform for said rotor rollers and said energy transferor;
(r) support ropes connected one end to ground, other end to top of rope rotor;
(s) support rotor wing connected to top part of said rope rotor;
(t) columns connected to said rope rotor and support it;
(u) floating platforms connected to said rope rotor and support it;
(v) tension elements (expansions, spreading, stretching) which supports said columns and said floating platforms;
(w) rotor in Darrieus form with controlled blades;
(x) propeller rotor with controlled blades;
(y) self support slope propeller;
(z) propeller rotor which can be turned in vertical position of its axis;
(aa) propeller rotor with blades which can be turned along rotor axis in direction flow;
(bb) one blade propeller with controlled blade;
(cc) propeller with propellerlets;
(dd) double propellers with opposed rotation;
(ee) double propeller with different diameter and different rotate speed;
(ff) rope transmission connected by one end to blade of said one blade rotor, by other end to said energy transferor;
(gg) balloon connected to said rotor for a support of said rotor in air;
(hh) floats connected to said rotor for a support of said installation in water.

6. The Installation as recited in claim 5 father includes at least one
of the following peculiarities:
(a) said rotor has cramps, which support said rotor rollers;
(b) part of said cramps have a shaft connected to said rotor rollers, said shaft has spherical ends;
(c) said spherical ends have bulge and connected to said transfer rollers, which have a groove; said bulge is located into said groove;
(d) one of said transfer rollers has also shaft with spherical ends having bulge and connected to said transfer rollers, which have a groove;
(e) transfer rollers have a cover and guides of transfer rope;
(f) wing of Darrieus rotor have a shaft connected to said rotor rope;
(g) said rotor rope has a bearing for said wing shaft;
(h) said rotor pulley mechanism of said rotor rope include at last one of the following parts: immobile rollers, mobile rollers connected one to other by rotor rope, engine; said mechanism changes a distance between immobile and mobile rollers and diameter of said rotor;
(i) said transfer pulley mechanism of said rotor rope include at last one of the following parts: immobile rollers, mobile rollers connected one to other by transmission rope, engine; said mechanism changes a distance between immobile and mobile rollers and a length of rope transferor;
(j) mobile blade of Darrieus rotor has parts: wing, flaps, stabilizer, elevator, bulk, fin, and control devices;
(k) flexible blades which include: connection bulk, blade bulk, back edge, cover, connection ropes and control devices;
(l) said parachutes, which have connection to said rotor rope in two points by an end of parachute cord (shroud lines) and by canopy top of said parachutes;
(m) said transmission of revolutions of said rope rollers includes three set of rollers having perpendicular axis and connected by transmission rope;
(n) redactor (transmission) of revolutions of said rope rollers includes: two set rollers having parallel axis;
(o) blades of said propeller have a central bulk, rotate sections, flaps, stabilizer, elevator, and control devices;
(p) propellerlet of said propeller includes: wing, flaps, and control devices;
(q) said rotor, connection, and transfer wings include flaps, ailerons, and control device;
(r) said rotor support wing rigid connected to said rotor and include flaps. Ailerons, fin, and control devices.

7. The Installation as recited in claim 4 further includes at least one of the following parts:
(a) energy station includes at least one of the following devices: motor-generator, gear boxes, clutches, reverse mechanisms, spools of rope, energy storage;
(b) said energy storage has an inertial flywheels;
(c) transferor includes at least one of the following devices: main rope connecting said rotor to the Earth surface, reverse mechanism, slide bearing, distance bar;
(d) said transfer rope is ribbon;
(e) said transfer ribbon has a holes and said transfer pulleys have regarded teeth (cogged rollers).

8. The Installation as recited in claim 5 father includes at least one
of the following peculiarities:
(a) said blades, wings, and parachutes at least one of the following design: inflatable, fabric, flexible plates;
(b) said ropes, ribbon, tension elements made from artificial fibers, whispers, nanotubes;
(c) said blades, wings, columns made from composed material;
(d) said parachutes made from artificial fiber fabric;

9. The Installation as recited in claim 4 father includes at least one
of the following features:
(a) said Installation located in air at high altitude up to 14 km;
(b) said Installation located in water flow, stream of a river, sea, ocean;
(c) said air Installation connected to ship produced energy and moved said ship.
